(19) United States
(12) Patent Application Publication
(10) Pub. No.: US 2015/0109685 A1
(43) Pub. Date: Apr. 23, 2015

(54) IMAGING LENS AND IMAGING APPARATUS EQUIPPED WITH THE IMAGING LENS

(71) Applicant: FUJIFILM CORPORATION, TOKYO (JP)

(72) Inventors: YOSHIKAZU SHINOHARA, SAITAMA-SHI (JP); MICHIO CHO, SAITAMA-SHI (JP)

(21) Appl. No.: 14/580,249

(22) Filed: Dec. 23, 2014

Related U.S. Application Data
(63) Continuation of application No. PCT/JP2013/003630, filed on Jun. 10, 2013.
(60) Provisional application No. 61/672,950, filed on Jul. 18, 2012.

(30) Foreign Application Priority Data
Jul. 4, 2012 (JP) 2012-150189

(51) Int. Cl. G02B 13/00; G02B 9/60

(52) U.S. Cl. CPC G02B 13/006; G02B 9/60; G02B 13/0045
USPC 359/714; 359/763

(57) ABSTRACT

An imaging lens is substantially constituted by six lenses, including: a first lens having a positive refractive power and a convex surface toward the object side; a second lens, which is cemented to the first lens, having a negative refractive power and a concave surface toward the image side; a third lens; a fourth lens; a fifth lens; and a sixth lens. The imaging lens satisfies predetermined conditional formulae.

### CROSS REFERENCE TO RELATED APPLICATIONS

The present application is a Continuation of PCT International Application No. PCT/JP2013/003630 filed on Jun. 10, 2013, which claims priority under 35 U.S.C. §119(a) to Japanese Patent Application No. 2012-150189 filed on Jul. 4, 2012 and U.S. Provisional Patent Application No. 61/672,950 filed on Jul. 18, 2012. Each of the above applications is hereby expressly incorporated by reference, in its entirety, into the present application.

### BACKGROUND OF THE INVENTION

1. Technical Field

The present invention is related to a fixed focus imaging lens for forming optical images of subjects onto an imaging element such as a CCD (Charge Coupled Device) and a CMOS (Complementary Metal Oxide Semiconductor). The present invention is also related to an imaging apparatus provided with the imaging lens that performs photography such as a digital still camera, a cellular telephone with a built in camera, a PDA (Personal Digital Assistant), a smart phone, a tablet type terminal, and a portable gaming device.

2. Background Art

Accompanying the recent spread of personal computers in households, digital still cameras capable of inputting image data such as photographed scenes and portraits into personal computers are rapidly becoming available. In addition, many cellular telephones, smart phones, and tablet type terminals are being equipped with camera modules for inputting images. Imaging elements such as CCD's and CMOS's are employed in these devices having photography functions. Recently, miniaturization of these imaging elements is advancing, and there is demand for miniaturization of the entirety of the photography devices as well as imaging lenses to be mounted thereon. At the same time, the number of pixels in imaging elements is increasing, and there is demand for high resolution and high performance of imaging lenses. Performance corresponding to 5 megapixels or greater, and more preferably 8 megapixels or greater, is desired.

In response to such demands, imaging lenses having a five lens configuration or a six lens configuration, which are comparatively large numbers of lenses, may be considered. For example, Korean Patent Publication No. 10-2010-0040357 and Chinese Utility Model Publication No. 202067015 propose imaging lenses with six lens configurations, constituted by: a first lens having a positive refractive power, a second lens having a negative refractive power, a third lens, a fourth lens, a fifth lens, and a sixth lens, provided in this order from the object side. In addition, Japanese Unexamined Patent Publication No. 2011-197254 discloses an imaging lens having a five lens configuration, in which the positive refractive power of a first lens is relatively increased in order to realize a shortening of the total length, and a third and fourth lenses form a cemented lens with a coupling surface having an aspherical shape in order to correct various aberrations and achieve high performance.

### DISCLOSURE OF THE INVENTION

Meanwhile, there is demand for imaging lenses for use in apparatuses which are becoming thinner such as smart phones and tablet terminals to have shorter total lengths. For this reason, it is desirable for the total lengths of imaging lenses to be shortened further, while realizing a sufficiently large image size which is compatible with the sizes of imaging elements having high resolutions. For this reason, there a further shortening of the total lengths is required in the imaging lenses disclosed in Korean Patent Publication No. 10-2010-0040357, Chinese Utility Model Publication No. 202067015, and Japanese Unexamined Patent Publication No. 2011-197254. In addition, further increased resolution is required of the imaging lens disclosed in Japanese Unexamined Patent Publication No. 2011-197254.

The present invention has been developed in view of the foregoing points. The object of the present invention is to provide an imaging lens that can realize a shortening of the total length while being capable of realizing high imaging performance from a central angle of view to peripheral angles of view. It is another object of the present invention to provide an imaging apparatus equipped with the lens, which is capable of obtaining high resolution photographed images.

An imaging lens of the present invention substantially consists of six lenses, including:

a first lens having a positive refractive power and a convex surface toward the object side;

a second lens, which is cemented to the first lens, having a negative refractive power and a concave surface toward the image side;

a third lens;

a fourth lens;

a fifth lens; and

a sixth lens, provided in this order from the object side;

the imaging lens satisfying the following conditional formulae:

0.4<f/f12<1.3 (1)

0.5<f/R6r<6 (2)

wherein f is the focal length of the entire system, f12 is the combined focal length of the first lens and the second lens, and R6r is the paraxial radius of curvature of the surface of the sixth lens toward the image side.

Note that in the imaging lens of the present invention, the expression “substantially consists of six lenses” means that the imaging lens of the present invention may also include lenses that practically have no power, optical elements other than lenses such as an aperture stop and a cover glass, and mechanical components such as lens flanges, a lens barrel, a camera shake correcting mechanism, etc., in addition to the six lenses.

The optical performance of the imaging lens of the present invention can be further improved by adopting the following favorable configurations.

In the imaging lens of the present invention, it is preferable for the coupling surface between the first lens and the second lens to be of an aspherical shape.

In the imaging lens of the present invention, it is preferable for the sixth lens to have a negative refractive power.

In the imaging lens of the present invention, it is preferable for the fourth lens to have a positive refractive power.

In the imaging lens of the present invention, it is preferable for the third lens to have a positive refractive power.

In the imaging lens of the present invention, it is preferable for an aperture stop to be positioned at the object side of the surface of the first lens toward the object side.

It is preferable for the imaging lens of the present invention to satisfy one of Conditional Formulae (1-1) through (5-1) below. Note that as a preferable aspect of the present invention, the imaging lens of the present invention may satisfy any one or arbitrary combinations of Conditional Formulae (1-1) through (5-1).

0.5<f/f12<1.1 (1-1)

1.5<f/R6r<5 (2-1)

0.1<T2/T1<1.0 (3)

0.1<T2/T1<0.3 (3-1)

−5<f/f6<−0.7 (4)

−2<f/f6<−0.9 (4-1)

0.15<T12/f<0.35 (5)

0.2<T12/f<0.3 (5-1)

wherein f is the focal distance of the entire system, f12 is the combined focal length of the first lens and the second lens, R6r is the paraxial radius of curvature of the surface of the sixth lens toward the image side, T2 is the central thickness of the second lens, T1 is the central thickness of the first lens, f6 is the focal length of the sixth lens, and T12 is the total thickness of the cemented lens formed by the first lens and the second lens along the optical axis.

An imaging apparatus of the present invention is equipped with the imaging lens of the present invention.

According to the imaging lens of the present invention, the configuration of each lens element is optimized within a lens configuration having six lenses as a whole, and the shapes of the first lens and the second lens are favorably configured in particular. Therefore, a lens system that can achieve a short total length while having high imaging performance from a central angle of view to peripheral angles of view can be realized.

The imaging apparatus of the present invention outputs image signals corresponding to optical images formed by the imaging lens of the present invention having high imaging performance. Therefore, the imaging apparatus of the present invention is capable of obtaining high resolution photographed images.

### BRIEF DESCRIPTION OF THE DRAWINGS

FIG. 1 is a sectional diagram that illustrates a first example of the configuration of an imaging lens according to an embodiment of the present invention, and corresponds to a lens of Example 1.

FIG. 2 is a sectional diagram that illustrates a second example of the configuration of an imaging lens according to an embodiment of the present invention, and corresponds to a lens of Example 2.

FIG. 3 is a sectional diagram that illustrates a third example of the configuration of an imaging lens according to an embodiment of the present invention, and corresponds to a lens of Example 3.

FIG. 4 is a sectional diagram that illustrates a fourth example of the configuration of an imaging lens according to an embodiment of the present invention, and corresponds to a lens of Example 4.

FIG. 5 is a sectional diagram that illustrates a fifth example of the configuration of an imaging lens according to an embodiment of the present invention, and corresponds to a lens of Example 5.

FIG. 6 is a sectional diagram that illustrates a sixth example of the configuration of an imaging lens according to an embodiment of the present invention, and corresponds to a lens of Example 6.

FIG. 7 is a sectional diagram that illustrates a seventh example of the configuration of an imaging lens according to an embodiment of the present invention, and corresponds to a lens of Example 7.

FIG. 8 is a sectional diagram that illustrates a eighth example of the configuration of an imaging lens according to an embodiment of the present invention, and corresponds to a lens of Example 8.

FIG. 9 is a sectional diagram that illustrates a ninth example of the configuration of an imaging lens according to an embodiment of the present invention, and corresponds to a lens of Example 9.

FIG. 10 is a sectional diagram that illustrates a tenth example of the configuration of an imaging lens according to an embodiment of the present invention, and corresponds to a lens of Example 10.

FIG. 11 is a sectional diagram that illustrates a eleventh example of the configuration of an imaging lens according to an embodiment of the present invention, and corresponds to a lens of Example 11.

FIG. 12 is a sectional diagram that illustrates a twelfth example of the configuration of an imaging lens according to an embodiment of the present invention, and corresponds to a lens of Example 12.

FIG. 13 is a sectional diagram that illustrates a thirteenth example of the configuration of an imaging lens according to an embodiment of the present invention, and corresponds to a lens of Example 13.

FIG. 14 is a diagram that illustrates the paths of light rays that pass through an imaging lens according to an embodiment of the present invention.

FIG. 15 is a collection of diagrams that illustrate aberrations of the imaging lens of Example 1, wherein A illustrates spherical aberration, B illustrates offense against the sine condition, C illustrates astigmatic aberration (field curvature), D illustrates distortion, and E illustrates lateral chromatic aberration.

FIG. 16 is a collection of diagrams that illustrate aberrations of the imaging lens of Example 2, wherein A illustrates spherical aberration, B illustrates offense against the sine condition, C illustrates astigmatic aberration (field curvature), D illustrates distortion, and E illustrates lateral chromatic aberration.

FIG. 17 is a collection of diagrams that illustrate aberrations of the imaging lens of Example 3, wherein A illustrates spherical aberration, B illustrates offense against the sine condition, C illustrates astigmatic aberration (field curvature), D illustrates distortion, and E illustrates lateral chromatic aberration.

FIG. 18 is a collection of diagrams that illustrate aberrations of the imaging lens of Example 4, wherein A illustrates spherical aberration, B illustrates offense against the sine condition, C illustrates astigmatic aberration (field curvature), D illustrates distortion, and E illustrates lateral chromatic aberration.

FIG. 19 is a collection of diagrams that illustrate aberrations of the imaging lens of Example 5, wherein A illustrates spherical aberration, B illustrates offense against the sine condition, C illustrates astigmatic aberration (field curvature), D illustrates distortion, and E illustrates lateral chromatic aberration.

FIG. 20 is a collection of diagrams that illustrate aberrations of the imaging lens of Example 6, wherein A illustrates spherical aberration, B illustrates offense against the sine condition, C illustrates astigmatic aberration (field curvature), D illustrates distortion, and E illustrates lateral chromatic aberration.

FIG. 21 is a collection of diagrams that illustrate aberrations of the imaging lens of Example 7, wherein A illustrates spherical aberration, B illustrates offense against the sine condition, C illustrates astigmatic aberration (field curvature), D illustrates distortion, and E illustrates lateral chromatic aberration.

FIG. 22 is a collection of diagrams that illustrate aberrations of the imaging lens of Example 8, wherein A illustrates spherical aberration, B illustrates offense against the sine condition, C illustrates astigmatic aberration (field curvature), D illustrates distortion, and E illustrates lateral chromatic aberration.

FIG. 23 is a collection of diagrams that illustrate aberrations of the imaging lens of Example 9, wherein A illustrates spherical aberration, B illustrates offense against the sine condition, C illustrates astigmatic aberration (field curvature), D illustrates distortion, and E illustrates lateral chromatic aberration.

FIG. 24 is a collection of diagrams that illustrate aberrations of the imaging lens of Example 10, wherein A illustrates spherical aberration, B illustrates offense against the sine condition, C illustrates astigmatic aberration (field curvature), D illustrates distortion, and E illustrates lateral chromatic aberration.

FIG. 25 is a collection of diagrams that illustrate aberrations of the imaging lens of Example 11, wherein A illustrates spherical aberration, B illustrates offense against the sine condition, C illustrates astigmatic aberration (field curvature), D illustrates distortion, and E illustrates lateral chromatic aberration.

FIG. 26 is a collection of diagrams that illustrate aberrations of the imaging lens of Example 12, wherein A illustrates spherical aberration, B illustrates offense against the sine condition, C illustrates astigmatic aberration (field curvature), D illustrates distortion, and E illustrates lateral chromatic aberration.

FIG. 27 is a collection of diagrams that illustrate aberrations of the imaging lens of Example 13, wherein A illustrates spherical aberration, B illustrates offense against the sine condition, C illustrates astigmatic aberration (field curvature), D illustrates distortion, and E illustrates lateral chromatic aberration.

FIG. 28 is a diagram that illustrates a cellular telephone as an imaging apparatus equipped with the imaging lens of the present invention.

FIG. 29 is a diagram that illustrates a smart phone as an imaging apparatus equipped with the imaging lens of the present invention.

### BEST MODE FOR CARRYING OUT THE INVENTION

Hereinafter, embodiments of the present invention will be described in detail with reference to the attached drawings.

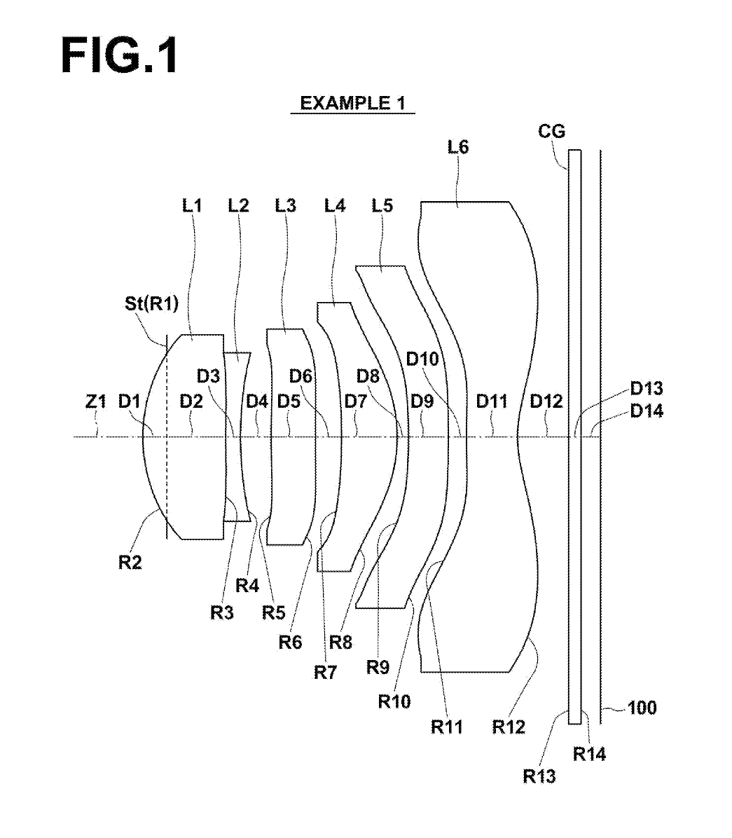

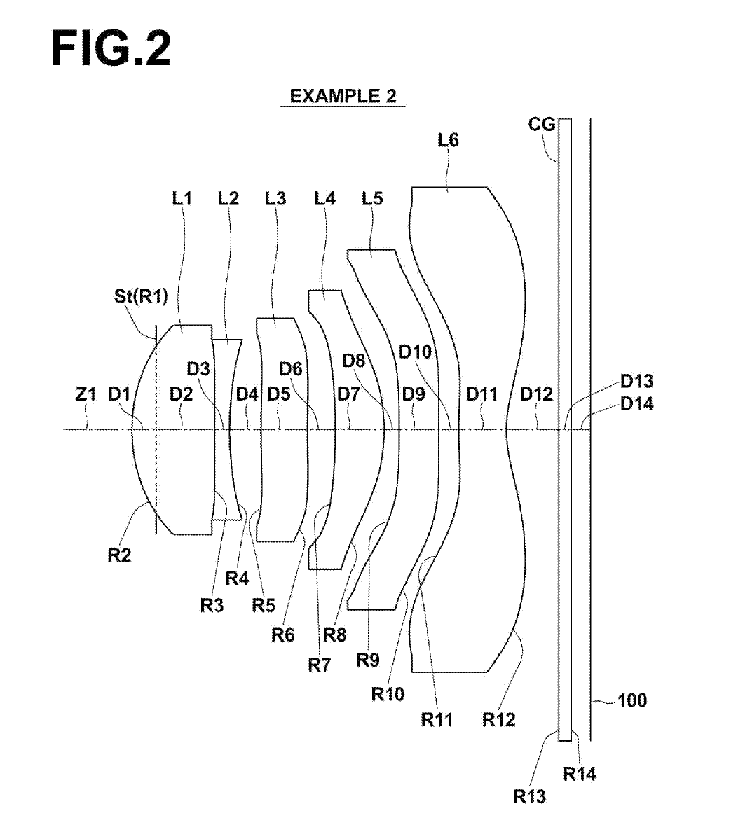

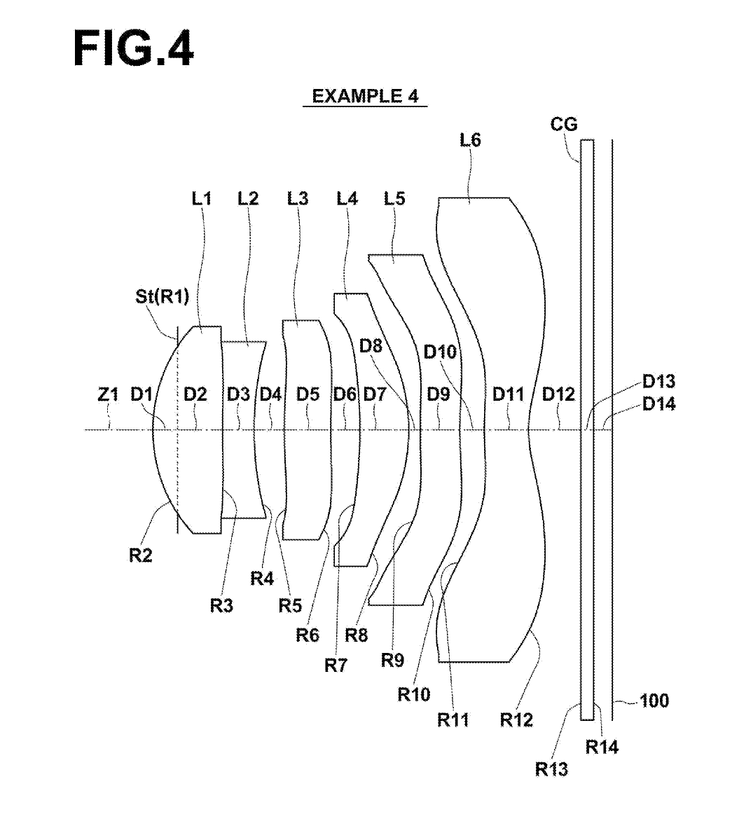

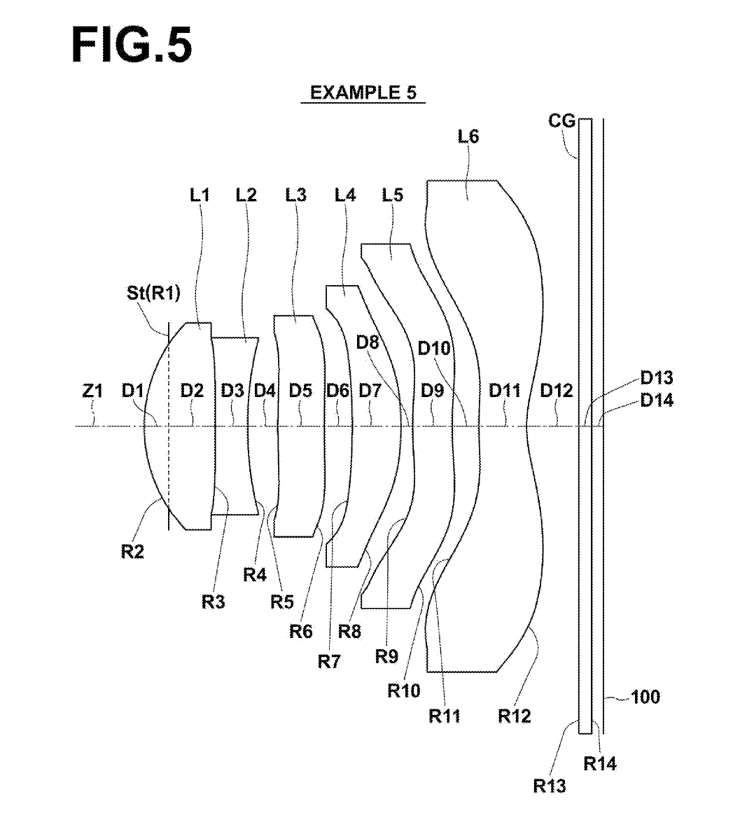

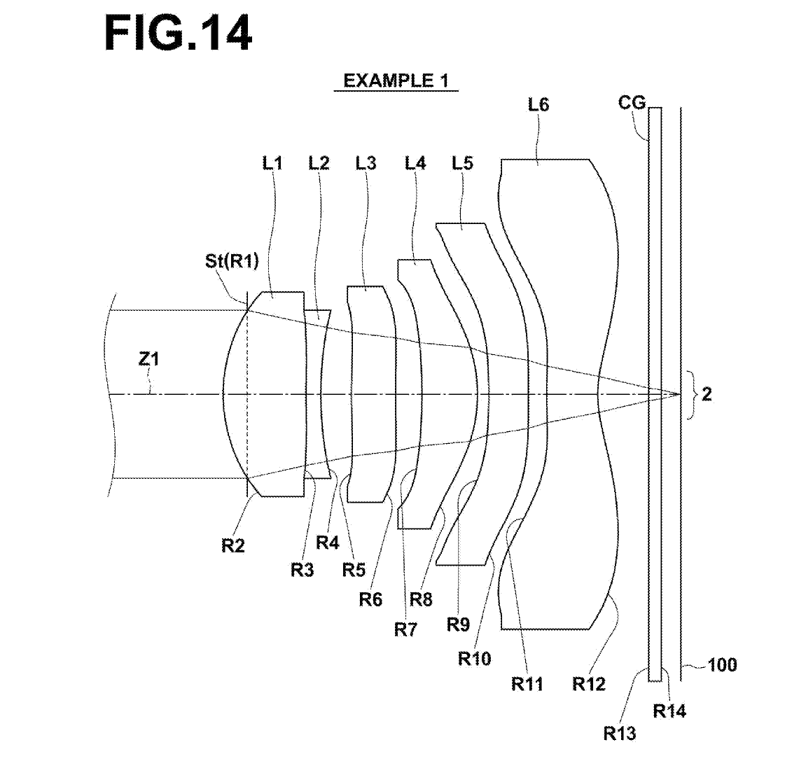

FIG. 1 illustrates a first example of the configuration of an imaging lens according to an embodiment of the present invention. This example corresponds to the lens configuration of Numerical Example 1 (Table 1 and Table 2), to be described later. Similarly, FIG. 2 through FIG. 13 are sectional diagrams that illustrate second through seventh examples of lens configurations that correspond to Numerical Examples 2 through 13 (Table 3 through Table 26). In FIGS. 1 through 13, the symbol Ri represents the radii of curvature of ith surfaces, i being lens surface numbers that sequentially increase from the object side to the image side (imaging side), with the surface of a lens element most toward the object side designated as first. The symbol Di represents the distances between an ith surface and an i+1st surface along an optical axis Z1. Note that the basic configurations of the examples are the same, and therefore a description will be given of the imaging lens of FIG. 1 as a base, and the examples of FIGS. 2 through 13 will also be described as necessary. In addition, FIG. 14 is a diagram that illustrates the paths of light rays that pass through the imaging lens L of FIG. 1, and illustrates the paths of axial light beams 2 from an object at a distance of infinity.

The imaging lens L of the embodiment of the present invention is favorably employed in various imaging devices that employ imaging elements such as a CCD and a CMOS. The imaging lens L of the embodiment of the present invention is particularly favorable for use in comparatively miniature portable terminal devices, such as a digital still camera, a cellular telephone with a built in camera, a smart phone, a tablet type terminal, and a PDA. The imaging lens L is equipped with a first lens L1, a second lens L2, a third lens L3, a fourth lens L4, a fifth lens L5, and a sixth lens L6, provided in this order from the object side.

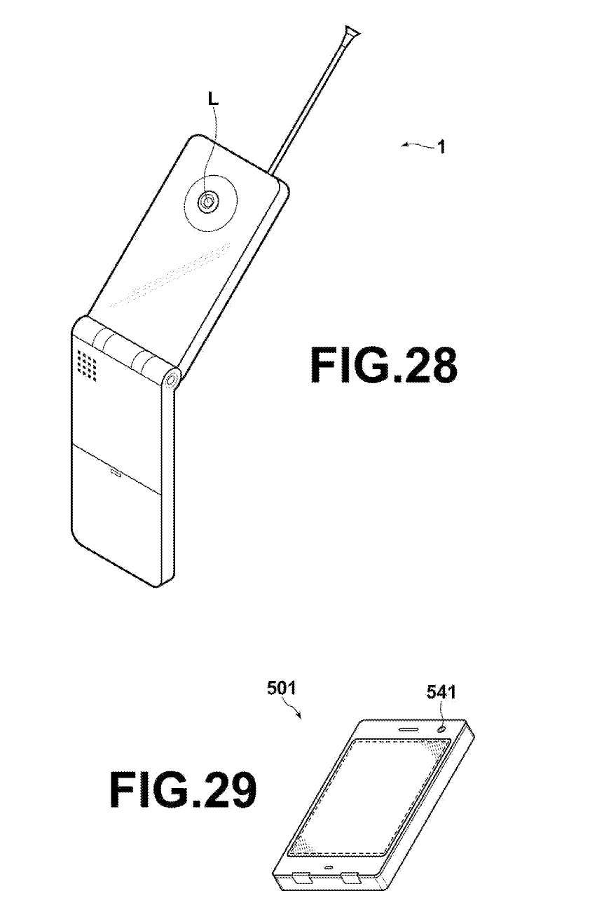

FIG. 28 schematically illustrates a cellular telephone as an imaging apparatus 1 according to an embodiment of the present invention. The imaging apparatus 1 of the embodiment of the present invention is equipped with the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

FIG. 29 schematically illustrates a smart phone as an imaging apparatus 501 according to an embodiment of the present invention. The imaging apparatus 501 of the embodiment of the present invention is equipped with a camera section 541 having the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

Various optical members CG may be provided between the sixth lens L6 and the imaging element 100, depending on the configuration of the camera to which the lens is applied. A planar optical member such as a cover glass for protecting the imaging surface and an infrared cutoff filter may be provided, for example. In this case, a planar cover glass having a coating having a filtering effect such as an infrared cutoff filter coating or an ND filter coating, or a material that exhibits similar effects, may be utilized as the optical member CG.

Alternatively, the optical member CG may be omitted, and a coating may be administered on the sixth lens L6 to obtain the same effect as that of the optical member CG Thereby, the number of parts can be reduced, and the total length can be shortened.

The imaging lens L is equipped with an aperture stop St positioned at the object side of the surface of the third lens L3 toward the object side. By positioning the aperture stop St at the object side of the surface of the third lens L3 toward the object side in this manner, increases in the incident angles of light rays that pass through the optical system and enter the image formation plane (imaging element) can be suppressed, particularly at peripheral portions of an imaging region. It is preferable for the apertures stop St to be positioned at the object side of the surface of the first lens L1 toward the object side in the direction of the optical axis, in order to cause this advantageous effect to become more prominent. Note that the expression “positioned at the object side of the surface of the third lens L3 toward the object side” means that the position of the aperture stop in the direction of the optical axis is at the same position as the intersection of marginal axial rays of light and the surface of the third lens L3 toward the object side, or more toward the object side than this position. Similarly, the expression “positioned at the object side of the surface of the first lens L1 toward the object side” means that the position of the aperture stop in the direction of the optical axis is at the same position as the intersection of marginal axial rays of light and the surface of the first lens L1 toward the object side, or more toward the object side than this position.

Further, in the case that the aperture stop St is positioned at the object side of the surface of the first lens L1 toward the object side in the direction of the optical axis, it is preferable for the aperture stop St to be positioned at the image side of the apex of the surface of the first lens L1 toward the object side, as in the lenses of Examples 1 through 5 and 7 through 13 to be described later (refer to FIGS. 1 through 5 and 7 through 13). In the case that the aperture stop St is positioned at the image side of the apex of the surface of the first lens L1 in this manner, the total length of the imaging lens including the aperture stop St can be shortened. However, the imaging lens of the present invention is not limited to this configuration, and the aperture stop St may be positioned at the object side of the apex of the surface of the first lens L1. A case in which the aperture stop St is positioned at the object side of the apex of the surface of the first lens L1 is somewhat disadvantageous from the viewpoint of securing peripheral light compared to a case in which the aperture stop St is positioned at the image side of the apex of the surface of the first lens L1. However, increases in the incident angles of light rays at peripheral portions of the imaging region that enter the image formation plane (imaging element) can be more favorably suppressed, particularly at the peripheral portions of the imaging region.

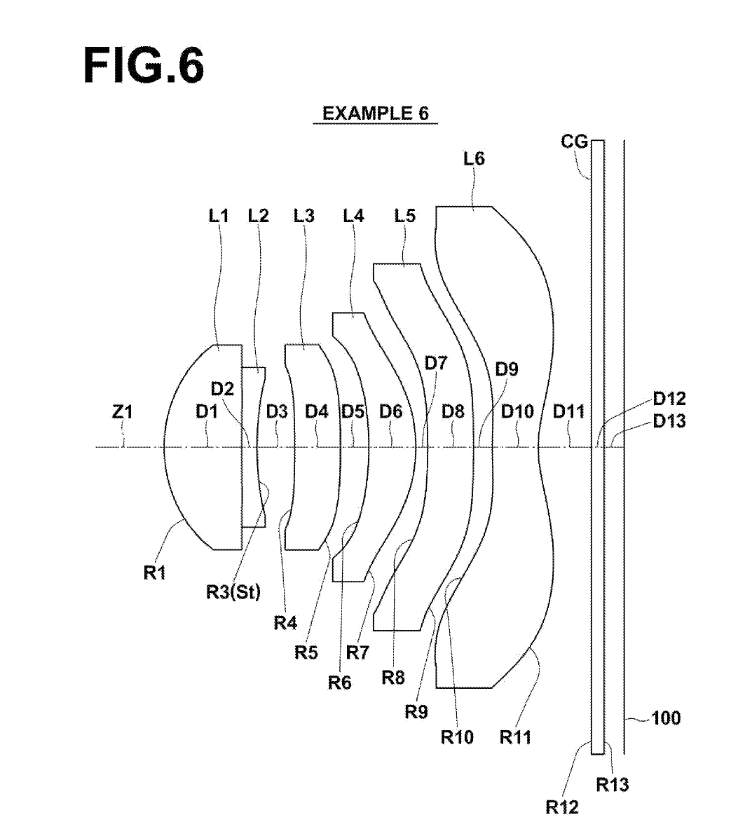

Alternatively, the aperture stop St may be positioned on the surface of the second lens L2 toward the image side, as in Example 6 (refer to FIG. 6). In this case, it is not necessary to provide a mechanism for supporting the aperture stop St more toward the object side than the first lens L1. Therefore, an advantageous effect that the length of the imaging lens including the mechanism for supporting the aperture stop St can be shortened in the direction of the optical axis can be expected. In addition, because the aperture stop St is provided on the surface of the cemented lens formed by the first lens L1 and the second lens L2 toward the image side, a single support mechanism can integrally support the cemented lens and the aperture stop St. This facilitates shortening of the total length to a greater degree than a case in which a mechanism for supporting the cemented lens and a mechanism for supporting the apertures stop St are provided separately.

In the imaging lens L, the first lens L1 has a positive refractive power in the vicinity of the optical axis. In addition, the first lens L1 has a convex surface toward the object side in the vicinity of the optical axis. By the first lens L1 having a convex surface toward the object side in the vicinity of the optical axis, the position of the rearward principal point of the first lens L1 can be closer to the object side, and the total length can be favorably shortened. It is preferable for the first lens L1 to be of a meniscus shape having a convex surface toward the object side in the vicinity of the optical axis as in Example 1, in order to cause this advantageous effect to become more prominent.

The second lens L2 has a negative refractive power in the vicinity of the optical axis. By the second lens L2 having a negative refractive power in the vicinity of the optical axis, spherical aberration, field curvature, and longitudinal chromatic aberration can be favorably corrected.

In addition, the second lens L2 is cemented to the first lens L1. By configuring the first lens L1 and the second lens L2 to be a cemented lens, no air interval is necessary between the first lens L1 and the second lens L2. As a result, the distance from the surface of the first lens L1 toward the object side to the surface of the second lens L2 toward the image side can be shortened, and shortening of the total length can be facilitated. In addition, it is generally necessary for the central thickness or the edge thickness (the thickness of the peripheral edge of a lens) of lenses to be a predetermined thickness or greater when producing the imaging lens L in order to secure a strength which is necessary during production. By configuring the first lens L1 and the second lens L2 to be a cemented lens and to be of a predetermined thickness that can secure a strength which is necessary during production or greater, the strength of the lens can be secured, while the central thickness or the edge thickness of at least one of the lenses can be made thinner than that of a single lens. As a result, shortening of the total length can be facilitated.

By cementing the first lens L1, which has a positive refractive power in the vicinity of the optical axis and a convex surface toward the object side in the vicinity of the optical axis, and the second lens L2, which has a negative refractive power in the vicinity of the optical axis and a concave surface toward the image side in the vicinity of the optical axis, together, the position of the rearward principal point can be closer to the object side, which is advantageous from the viewpoint of shortening the total length.

In addition, it is preferable for the coupling surface between the first lens L1 and the second lens L2 to be of an aspherical shape. By providing the aspherical coupling surface between the first lens L1 and the second lens L2 adjacent to the first lens L1 having a positive refractive power toward the image side thereof, various aberrations, such as spherical aberration, comatic aberration, and astigmatism, which are generated when light rays pass through the surface of the first lens L1 toward the object side, can be favorably corrected. In contrast, if the positive refractive power of a first lens is relatively increased and a third lens and a fourth lens form a cemented lens with an aspherical coupling surface as in Japanese Unexamined Patent Publication No. 2011497254, the distance between the first lens and the cemented lens will be great. Therefore, the effect of various aberrations, which are generated when light rays pass through the first lens, being corrected by the cemented lens will become less prominent.

In addition, the cemented lens may be produced by cementing two lenses which are individually molded (or ground) together, or produced by forming a second lens on the surface of a molded (or ground) first lens by a technique such as molding. In the latter case, the problem that the two lenses will be cemented together in an eccentric manner from a desired position will not occur in principle. Adopting this technique facilitates forming of the shape of surface of the second lens to be cemented to match the shape of the surface of the first lens onto which the second lens is cemented, even in the case that the coupling surface of the two lenses is aspherical. Therefore, the cemented lens can be highly precisely and easily produced.

It is preferable for the third lens L3 to have a positive refractive power in the vicinity of the optical axis. Thereby, comatic aberration can be favorably corrected. In addition, it is preferable for the third lens L3 to have a convex surface toward the object side in the vicinity of the optical axis. In the case that the third lens L3 has a convex surface toward the object side in the vicinity of the optical axis, the position of the rearward principal point of the third lens L3 can be closer to the object side, and shortening of the total length can be favorably realized. It is more preferable for the third lens L3 to be of a meniscus shape having a convex surface toward the object side in the vicinity of the optical axis as in Example 1, in order to cause this advantageous effect to become more prominent.

In the case that the first lens L1 having a positive refractive power in the vicinity of the optical axis, the second lens L2 having a negative refractive power in the vicinity of the optical axis, and the third lens L3 having a positive refractive power in the vicinity of the optical axis are provided in this order from the object side as in Example 1, comatic aberration can be more favorably corrected.

It is preferable for the fourth lens L4 to have a positive refractive power in the vicinity of the optical axis. Particularly in imaging lenses having short total lengths which are employed in cellular telephones and the like, the tendency for incident angles of light rays that enter imaging elements to become large as the angle of view becomes larger is significant. Therefore, it is preferable for the incident angles with respect to imaging elements to be suppressed such that they do not become excessively great from a central angle of view to peripheral angles of view, to prevent various problems caused by the increase in incident angles, such as deterioration of light receiving efficiency and color mixing. In the case that the fourth lens L4 has a positive refractive power in the vicinity of the optical axis, excessive increases of the incident angles of light rays that enter the imaging element at a central angle of view can be favorably suppressed, and excessive increases of the incident angles of light rays that enter the imaging element can be favorably suppressed from a central angle of view to peripheral angles of view. In addition, it is preferable for the fourth lens L4 to be of a meniscus shape having a convex surface toward the image side in the vicinity of the optical axis, as in Example 1. Astigmatism can be favorably corrected by adopting this configuration.

The fifth lens L5 may have a negative refractive power or a positive refractive power in the vicinity of the optical axis, as long as it is capable of correcting various aberrations which are generated when light rays pass through the first lens L1 through the fourth lens L4 in a balanced manner. For example, the fifth lens L5 may have a negative refractive power in the vicinity of the optical axis and be of a meniscus shape having a concave surface toward the object side in the vicinity of the optical axis as in Example 1. in this case, field curvature can be favorably corrected. In addition, it is preferable for both surfaces of the fifth lens L5 to be aspherical. In this case, astigmatism, lateral chromatic aberration, etc. at intermediate angles of view and at peripheral angles of view can be corrected in a well balanced manner.

It is preferable for the sixth lens L6 to have a negative refractive power in the vicinity of the optical axis. By the sixth lens L6 having a negative refractive power in the vicinity of the optical axis, the total length can be shortened, while field curvature can be favorably corrected. In addition, it is preferable for the sixth lens L6 to have a concave surface toward the image side in the vicinity of the optical axis. In the case that the sixth lens L6 has a concave surface toward the image side in the vicinity of the optical axis, the total length can be favorably shortened. It is more preferable for the sixth lens L6 to be of a meniscus shape having a concave surface toward the image side in the vicinity of the optical axis, to cause this advantageous effect to become more prominent. In addition, in the case that the sixth lens L6 has a concave surface toward the image side in the vicinity of the optical axis, it is preferable for the surface of the sixth lens L6 toward the image side to be an aspherical shape having an inflection point. In the case that the sixth lens L6 has a concave surface toward the image side, field curvature can be favorably corrected, and increases in the incident angles of light rays that pass through the optical system and enter the image formation surface (imaging element) can be suppressed, particularly at the peripheral portions of the imaging region, by the surface of the sixth lens L6 being of an aspherical shape having an inflection point. It is preferable for the sixth lens L6 to be of a meniscus shape having a concave surface toward the image side in the vicinity of the optical axis, and for both surfaces of the sixth lens L6 to be aspherical and to have inflection points thereon, in order to cause this advantageous effect to become more prominent. Example 1 is an example of a configuration in which the sixth lens L6 has a negative refractive power, is of a meniscus shape having a concave surface toward the image side, and in which both surfaces are aspherical in shape and have an inflection point thereon.

It is preferable for at least one of the surfaces of each of the first lens L1 through the sixth lens L6 of the imaging lens L to be an aspherical surface, in order to improve performance.

Next, the operation and effects of conditional formulae related to the imaging lens L will be described in greater detail.

First, the combined focal length f12 of the first lens L1 and the second lens L2 and the focal length f of the entire system satisfy Conditional Formula (1) below.

0.4<f/f12<1.3 (1)

Conditional Formula (1) defines a preferable range of numerical values for the ratio of the focal length f of the entire system with respect to the combined focal length f12 of the first lens L1 and the second lens L2. In the case that the value of f/f12 is less than the lower limit defined in Conditional Formula (1), the positive refractive index of the cemented lens formed by the first lens L1 and the second lens L2 will become excessively strong with respect to the refractive power of the entire system, which is disadvantageous from the viewpoint of shortening the total length. In the case that the value of f/f12 is greater than the upper limit defined in Conditional Formula (1), the refractive index of the cemented lens formed by the first lens L1 and the second lens L2 will become excessively weak with respect to the refractive power of the entire system, and correction of spherical aberration and longitudinal chromatic aberration will become difficult. For these reasons, the total length can be favorably shortened while favorably correcting spherical aberration and longitudinal chromatic aberration, by Conditional Formula (1) being satisfied. From the above viewpoint, it is more preferable for Conditional Formula (1-1) below to be satisfied, and even more preferable for Conditional Formula (1-2) below to be satisfied.

0.5<f/f12<1.1 (1-1)

0.6<f/f12<1.0 (1-2)

In addition, the paraxial radius of curvature R6r of the surface of the sixth lens L6 toward the image side and the focal length f of the entire system satisfy Conditional Formula (2) below.

0.5<f/R6r<6 (2)

Conditional Formula (2) defines a preferable range of numerical values for the ratio of the focal length f of the entire system with respect to the paraxial radius of curvature R6r of the surface of the sixth lens L6 toward the image side. In the case that the value of f/R6r is less than the lower limit defined in Conditional Formula (2), such a configuration is disadvantageous from the viewpoint of shortening the total length, and it will also become difficult to sufficiently correct field curvature. In the case that the value of f/R6r is greater than the upper limit defined in Conditional Formula (2), it will become difficult to sufficiently suppress increases in the incident angles of light rays that enter the imaging element, particularly at intermediate angles of view. For these reasons, increases in the incident angles of light rays that enter the imaging element can be favorably suppressed by Conditional Formula (2) being satisfied. In addition, the total length can be favorably shortened while favorably correcting field curvature. From the above viewpoint, it is more preferable for Conditional Formula (2-1) below to be satisfied, and even more preferable for Conditional Formula (2-2) below to be satisfied.

1.5<f/R6r<5 (2-1)

2.0<f/R6r<4 (2-2)

In addition, it is preferable for the central thickness of the second lens L2 and the central thickness of the first lens L1 to satisfy Conditional Formula (3) below.

0.1<T2/T1<1.0 (3)

Conditional Formula (3) defines preferred ranges of numerical values for the central thickness of the second lens L2 and the central thickness of the first lens L1. In the case that the value of T2/T1 is less than the lower limit defined in Conditional Formula (3), the distance between the surface of the second lens L2 toward the object side (coupling surface) and the surface of the second lens L2 toward the image side will become short. This will result in the correcting effect obtained by the surface of the second lens L2 toward the object side (coupling surface) and the surface of the second lens L2 toward the image side having different shapes not being sufficiently exhibited, particularly with respect to off axis light rays. Therefore, such a configuration is disadvantageous from the viewpoint of balancing spherical aberration and comatic aberration. In the case that the value of T2/T1 is greater than the upper limit defined in Conditional Formula (3), such a configuration is disadvantageous from the viewpoint of shortening the total length. The total length can be favorably shortened, while spherical aberration and comatic aberration can be favorably corrected, by Conditional Formula (3) being satisfied. From the above viewpoint, it is more preferable for Conditional Formula (3-1) below to be satisfied, and even more preferable for Conditional Formula (3-2) below to be satisfied. Note that in the lens data shown in Tables 1 through 26 below, in the examples of configurations in which the aperture stop St is positioned at the object side of the surface of the first lens L1 toward the object side, D2 corresponds to T1 and D3 corresponds to T2. In addition, in the examples of configurations in which the aperture stop St is positioned on the surface of the second lens L2 toward the image side, D1 corresponds to T1 and D2 corresponds to T2.

0.1<T2/T1<0.3 (3-1)

0.15<T2/T1<0.25 (3-2)

In addition, it is preferable for the focal length f of the entire system and the focal length f6 of the sixth lens L6 to satisfy Conditional Formula (4) below.

−5<f/f6<−0.7 (4)

Conditional Formula (4) defines a preferable range of numerical values for the focal length f of the entire system with respect to the focal length f6 of the sixth lens L6. In the case that the value of f/f6 is less than the lower limit defined in Conditional Formula (4), the negative refractive power of the sixth lens L6 will become excessively strong with respect to the refractive power of the entire system, and it will become difficult to sufficiently suppress increases in the incident angles of light rays that enter the imaging element, particularly at intermediate angles of view. In the case that the value of f/f6 is greater than the upper limit defined in Conditional Formula (4), the negative refractive power of the sixth lens L6 will become excessively weak with respect to the refractive power of the entire system, which is disadvantageous from the viewpoint of shortening the total length and correcting field curvature. In addition, the total length can be favorably shortened while favorably correcting field curvature, by Conditional Formula (4) being satisfied. In addition, increases in the incident angles of light rays that enter the imaging element can be favorably suppressed, and increases in the incident angles of light rays that enter the imaging element at intermediate angles of view through peripheral angles of view can be favorably suppressed. From the above viewpoint, it is more preferable for Conditional Formula (4-1) below to be satisfied, and even more preferable for Conditional Formula (4-2) below to be satisfied.

−2<f/f6<−0.9 (4-1)

−1.5<f/f6<−0.95 (4-2)

In addition, the total thickness T12 of the cemented lens formed by the first lens L1 and the second lens L2 along the optical axis and the focal length f of the entire system satisfy Conditional Formula (5) below.

0.15<T12/f<0.35 (5)

Conditional Formula (5) defines a preferable range of numerical values for the total thickness T12 of the cemented lens formed by the first lens L 1 and the second lens L2 along the optical axis with respect to the focal length f of the entire system. In the case that the value of T12/f is less than the lower limit defined in Conditional Formula (5), the effect of the cemented lens formed by the first lens L1 and the second lens L2 moving the rearward principal point toward the object side will become weak, which is disadvantageous from the viewpoint of shortening the total length. In the case that the value of T12/f is greater than the upper limit defined in Conditional Formula (5), the ratio occupied by the total thickness T12 of the cemented lens formed by the first lens L1 and the second lens L2 along the optical axis with respect to the focal length f of the entire system will become great, which is also disadvantageous from the viewpoint of shortening the total length. A shortening of the total length can be favorably realized by Conditional Formula (5) being satisfied. From the above viewpoint, it is more preferable for Conditional Formula (5-1) below to be satisfied, and even more preferable for Conditional Formula (5-2) below to be satisfied.

0.2<T12/f<0.3 (5-1)

0.22<T12/f<0.3 (5-2)

Next, the imaging lenses of Example 2 through Example 13 of the present invention will be described in detail with reference to FIGS. 2 through 13. In the imaging lenses of Examples 1 through 13 illustrated in FIGS. 1 through 13, all of the surfaces of the first lens L1 through the sixth lens L6 are aspherical. In addition, each of the imaging lenses of Example 2 through Example 13 of the present invention are constituted by a first lens L1 having a positive refractive power and a convex surface toward the object side, a second lens L2, which is cemented to the first lens L1, having a negative refractive power and a concave surface toward the image side, a third lens L3, a fourth lens L4, a fifth lens L5 and a sixth lens L6, provided in this order from the object side. For this reason, only the other detailed configurations of each lens of Examples 2 through 13 will be described in connection with Examples 2 through 13 below. In addition, the operational effects of configurations which are common among Examples 1 through 13 are the same. Therefore, the configurations and the operational effects thereof will be described for lower numbered Examples, and redundant descriptions of the common configurations and the operational effects thereof will be omitted for the other embodiments.

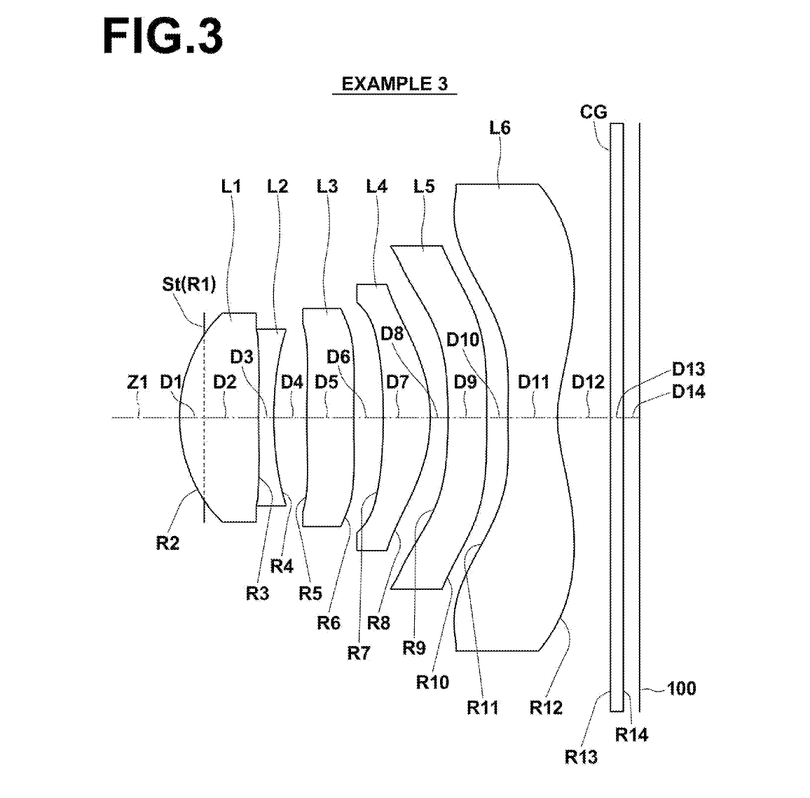

The configurations of the first lens L1 through the sixth lens L6 of the imaging lenses L of Example 2 illustrated in FIG. 2 and Example 3 illustrated in FIG. 3 are the same as those of Example 1. The same operational effects corresponding to each of the lens configurations as those obtained by Example 1 are obtained by the imaging lenses of Example 2 and Example 3.

The fifth lens L5 may have a negative refractive power in the vicinity of the optical axis, be of a meniscus shape having a concave surface toward the image side in the vicinity of the optical axis, and both surfaces of the fifth lens L5 may be aspherical shapes having inflection points thereon. In this case, the orientations of the projection and recess of both surfaces of the fifth lens L5 of Example 4 in the vicinity of the optical axis are opposite those of the fifth lens L5 of Example 1. However, field curvature can be favorably corrected, by the fifth lens L5 being of a meniscus shape having a concave surface toward the image side in the vicinity of the optical axis, and both surfaces of the fifth lens L5 being aspherical shapes having inflection points thereon. In addition, the configurations of the first lens L 1 through the fourth lens L4 and the sixth lens L6 of the imaging lens of Example 4 are the same as those of Example 1. The same operational effects are obtained by the configurations of these lenses corresponding to those of Example 1.

The fifth lens L5 may have a positive refractive power in the vicinity of the optical axis, be of a meniscus shape having a convex surface toward the object side in the vicinity of the optical axis, and both surfaces of the fifth lens L5 may be aspherical shapes having inflection points thereon. In the case that the fifth lens L5 has a positive refractive power in the vicinity of the optical axis as well, field curvature can be favorably corrected, by the fifth lens L5 being of a meniscus shape having a convex surface toward the object side in the vicinity of the optical axis, and both surfaces of the fifth lens L5 being aspherical shapes having inflection points thereon. In addition, the configurations of the first lens L1 through the fourth lens L4 and the sixth lens L6 of the imaging lens of Example 5 are the same as those of Example 1. The same operational effects are obtained by the configurations of these lenses corresponding to those of Example 1.

The aperture stop St may be configured to be of the same shape as the surface of the second lens L2 toward the image side and provided on the surface of the second lens L2 toward the image side, and the third lens L3 may have a positive refractive power in the vicinity of the optical axis and be of a meniscus shape having a convex surface toward the image side in the vicinity of the optical axis, as in Example 6 illustrated in FIG. 6. The advantageous effect obtained by the position and shape of the aperture stop is as described previously. Comatic aberration can be favorably corrected in the case that the third lens L3 is of a meniscus shape having a convex surface toward the image side in the vicinity of the optical axis as well. In addition, In addition, the configurations of the first lens L1 and the fourth lens L4 through the sixth lens L6 of the imaging lens of Example 6 are the same as those of Example 1. The same operational effects are obtained by the configurations of these lenses corresponding to those of Example 1.

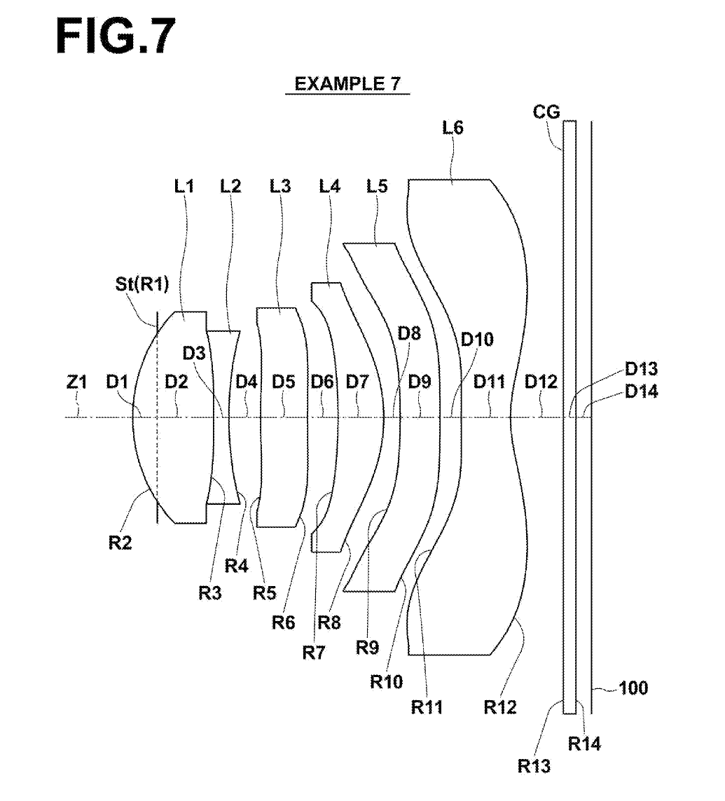

The configurations of the first lens L1 through the sixth lens L6 of Example 7 illustrated in FIG. 7 are the same as those of Example 1. The same operational effects corresponding to each of the lens configurations as those obtained by Example 1 are obtained by the imaging lens of Example 7.

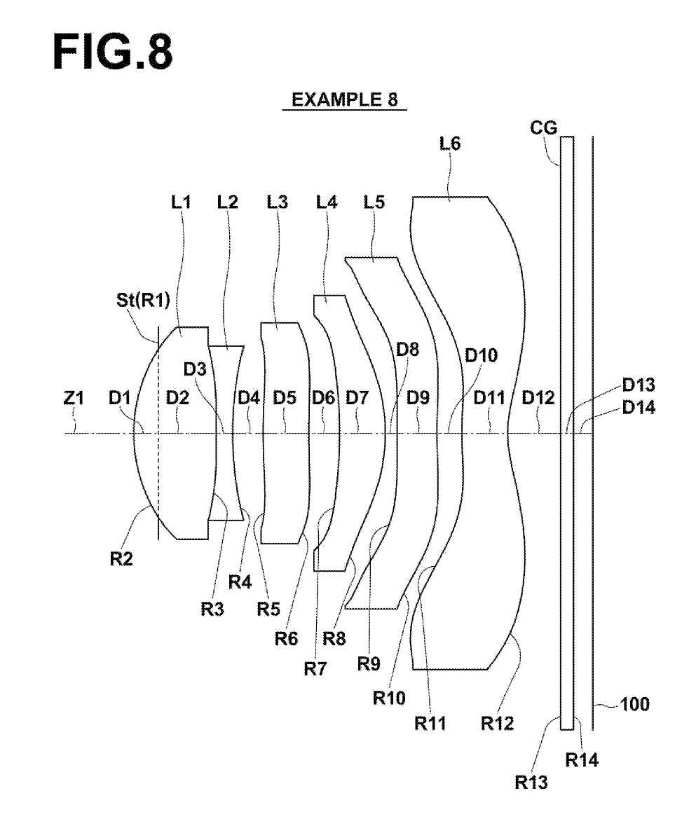

The coupling surface between the first lens L1 and the second lens L2 may be of a convex shape toward the image side in the vicinity of the optical axis, the fifth lens L5 may be of a biconcave shape in the vicinity of the optical axis, and both surfaces of the fifth lens L5 may be aspherical shapes having inflection points thereon, as in the imaging lens L of Example 8 illustrated in FIG. 8. Spherical aberration can be favorably corrected, by the coupling surface between the first lens L1 and the second lens L2 being of a convex shape toward the image side in the vicinity of the optical axis. In this case, the orientation of the projection or recess of the surface of the fifth lens L5 toward the object side in the vicinity of the optical axis is opposite that of Example 1. However, field curvature can be favorably corrected even in the case that the fifth lens L5 is of a biconcave shape in the vicinity of the optical axis, by both surfaces of the fifth lens L5 being aspherical shapes having inflection points thereon. In addition, the configurations of the third lens L3, the fourth lens L4, and the sixth lens L6 of the imaging lens of Example 8 are the same as those of Example 1. The same operational effects are obtained by the configurations of these lenses corresponding to those of Example 1.

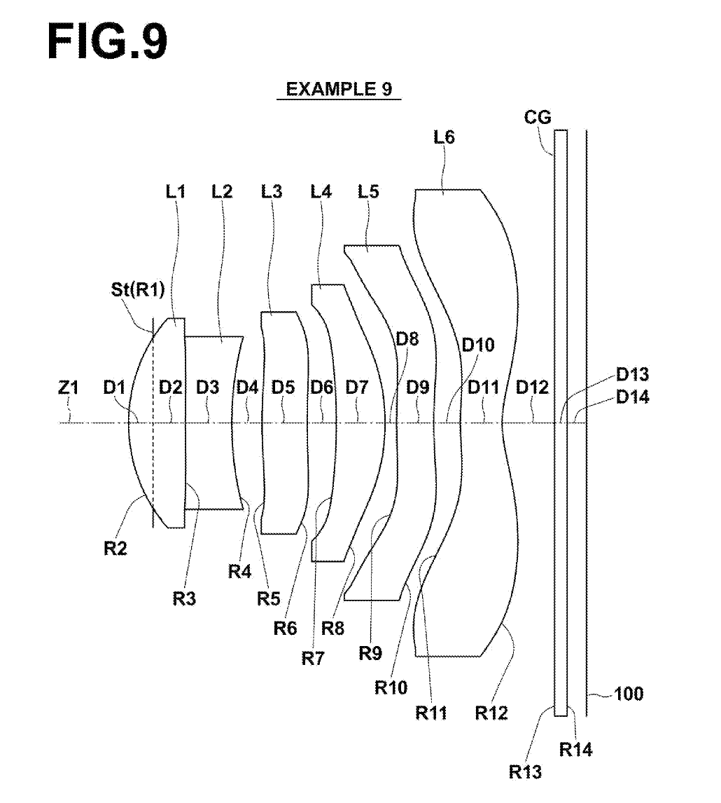

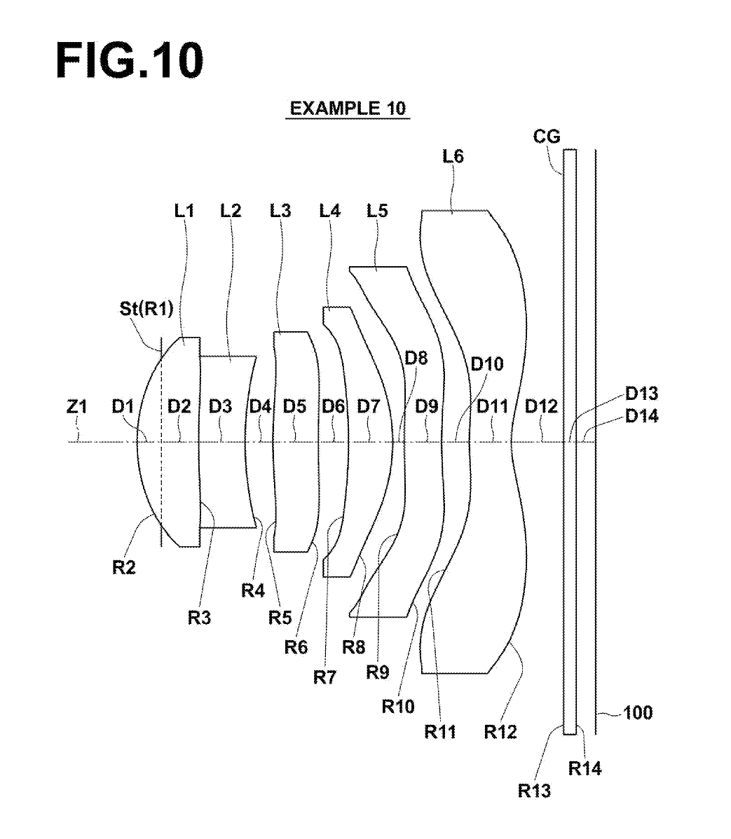

The configurations of the first lens L1 through the sixth lens L6 of the imaging lenses L of Example 9 illustrated in FIG. 9 and Example 10 illustrated in FIG. 10 are the same as those of Example 4. The same operational effects corresponding to each of the lens configurations as those obtained by Example 4 are obtained by the imaging lenses of Example 9 and Example 10.

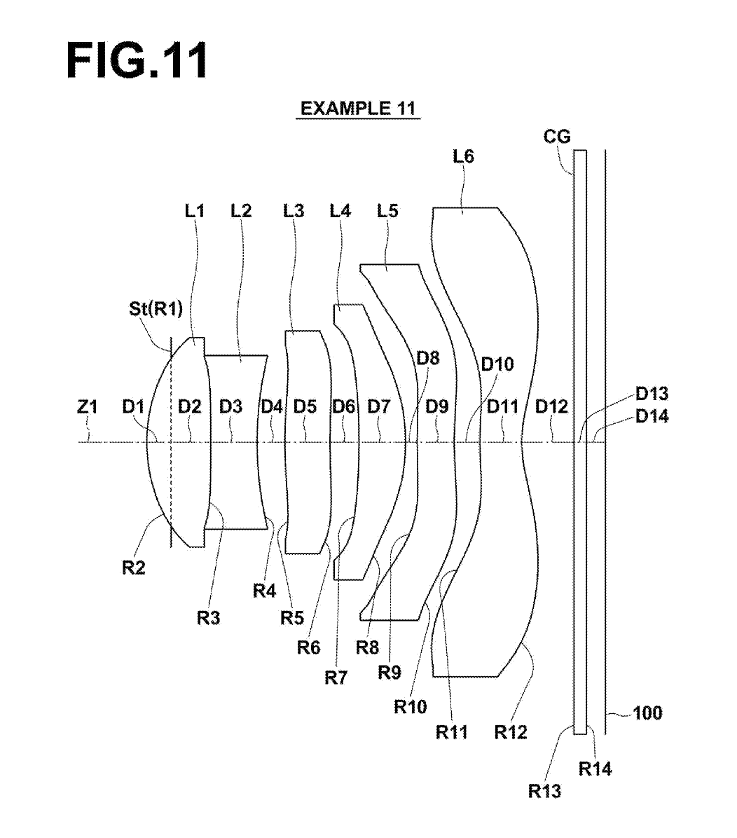

The coupling surface of the first lens L1 and the second lens L2 may be of a convex shape toward the image side in the vicinity of the optical axis as in Example 8, and the configurations of the third lens L3 through the sixth lens L6 may be the same as those of Example 4, as in the imaging lens L of Example 11 illustrated in FIG. 11. The configurations of the first through sixth lenses of Example 11 enable the operational effects obtained by the configurations of Examples 8 and 4 corresponding thereto to be obtained.

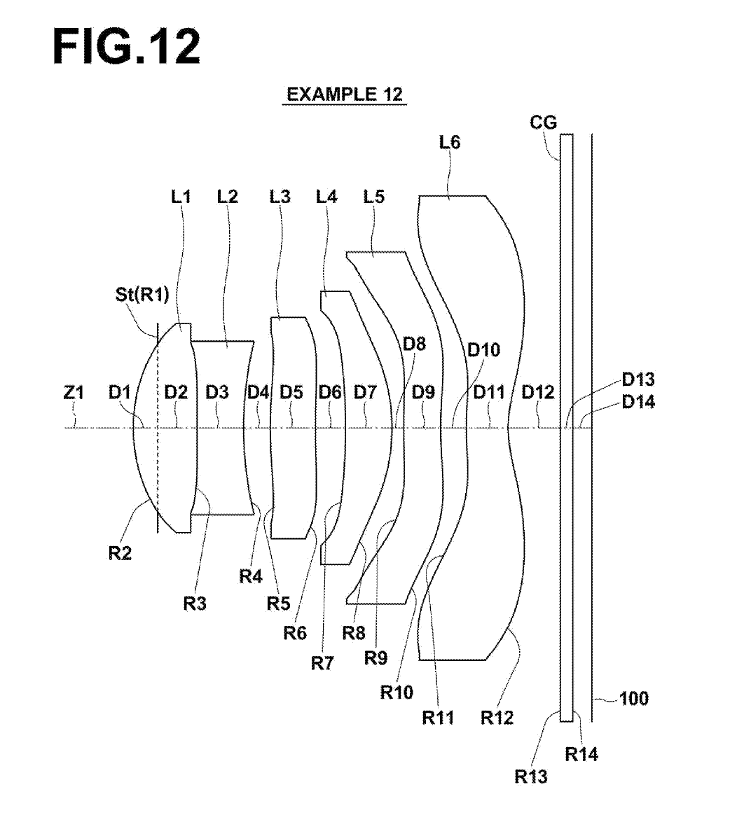

The configurations of the first lens L1 through the sixth lens L6 of the imaging lens L of Example 12 illustrated in FIG. 12 are the same as those of Example 11. The same operational effects corresponding to each of the lens configurations as those obtained by Example 11 are obtained by the imaging lens of Example 12.

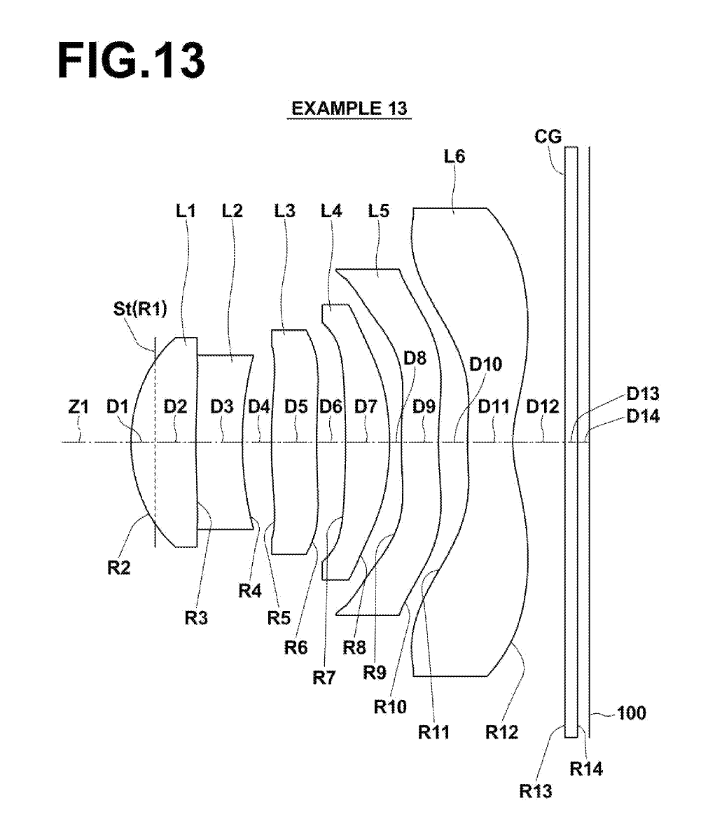

The configurations of the first lens L1 through the sixth lens L6 of the imaging lens L of Example 13 illustrated in FIG. 13 are the same as those of Example 4. The same operational effects corresponding to each of the lens configurations as those obtained by Example 4 are obtained by the imaging lenses of Example 9 and Example 13.

In Examples 1 through 8, the thicknesses of the cemented lenses formed by the first lenses L1 and the second lenses L2 are maintained as a predetermined thickness required for production, and the second lenses L2 are configured such that the central thicknesses T2 thereof are relatively thin. In addition, in Examples 9 through 13, the thicknesses of the cemented lenses formed by the first lenses L1 and the second lenses L2 are maintained at a predetermined thickness required for production, and the first lenses L1 are configured such that the edge thicknesses thereof are relatively thin. There is a possibility that the central thicknesses of the second lenses L2 of Examples 1 through 7 and the edge thicknesses of the first lenses of Examples 8 through 13 will result in insufficient strength to withstand assembly steps during production as single lenses. However, because the thicknesses of the cemented lenses are maintained at the predetermined thickness required for production, the cemented lenses can be favorably applied to the production of imaging lenses.

As described above, in the imaging lenses L of the Examples of the present invention, the configuration of each lens element is optimized within a lens configuration having six lenses as a whole, and the shapes of the first lens and the second lens are favorably configured in particular. Therefore, a lens system that can achieve a short total length while having high imaging performance can be realized.

Further improved imaging performance can be realized by appropriately satisfying preferred conditions. In addition, the imaging apparatuses according to the embodiments of the present invention output image signals corresponding to optical images formed by the high performance imaging lenses L according to the embodiments of the present invention. Therefore, photographed images having high resolution from a central angle of view to peripheral angles of view can be obtained.

Next, specific examples of numerical values of the imaging lens of the present invention will be described. A plurality of examples of numerical values will be summarized and explained below.

Table 1 and Table 2 below show specific lens data corresponding to the configuration of the imaging lens illustrated in FIG. 1. Specifically, Table 1 shows basic lens data of the imaging lens, and Table 2 shows data related to aspherical surfaces. In the lens data of Table 1, ith numbers of the surfaces of lens elements that sequentially increase from the object side to the image side, with the lens element at the most object side designated as first (the aperture stop St is first), are shown in the column Si for the imaging lens of Example 1. The radii of curvature (mm) of ith surfaces from the object side corresponding to the symbols Ri illustrated in FIG. 1 are shown in the column Ri. Similarly, the distances (mm) between an ith surface Si and an i+1 st surface Si+1 from the object side along the optical axis Z are shown in the column Di. The refractive indices of jth optical elements from the object side with respect to the d line (wavelength: 587.56 nm) are shown in the column Ndj. The Abbe's numbers of the jth optical elements with respect to the d line are shown in the column vdj. In addition, Table 1 also shows the focal length f (mm) of the entire system, and the back focus Bf (mm) as various data. Note that the back focus Bf is represented as an air converted value, and the air converted value is employed as the portion of a total length TL of the lens corresponding to the back focus Bf.

In the imaging lens of Example 1, both of the surfaces of all of the first lens L1 through the sixth lens L6 are aspherical in shape. In the basic lens data of Table 1, numerical values of radii of curvature in the vicinity of the optical axis (paraxial radii of curvature) are shown as the radii of curvature of the aspherical surfaces.

Table 2 shows aspherical surface data of the imaging lens of Example 1. In the numerical values shown as the aspherical surface data, the symbol “E” indicates that the numerical value following thereafter is a “power index” having 10 as a base, and that the numerical value represented by the index function having 10 as a base is to be multiplied by the numerical value in front of “E”. For example, “1.0E-02” indicates that the numerical value is “1.0·10⁻²”.

The values of coefficients Ai and K represented by the aspherical surface shape formula (A) below are shown as the aspherical surface data. In greater detail, Z is the length (mm) of a normal line that extends from a point on the aspherical surface having a height h to a plane (a plane perpendicular to the optical axis) that contacts the apex of the aspherical surface.

Z=C·h²/{1+(1−K·C²·h²)^{1/2}}+ΣAi·hⁱ (A)

wherein: Z is the depth of the aspherical surface (mm), h is the distance from the optical axis to the surface of the lens (height) (mm), C is the paraxial curvature=1/R (R is the paraxial radius of curvature), Ai is an ith ordinal aspherical surface coefficient (i is an integer 3 or greater), and K is an aspherical surface coefficient.

Detailed lens data corresponding to the configuration of the imaging lens illustrated in FIG. 2 are shown in Table 3 and Table 4 as Example 2, in the same manner as that for Example 1. Similarly, detailed lens data corresponding to the configurations of the imaging lenses illustrated in FIG. 3 through FIG. 13 are shown in Tables 5 through 26 as Example 3 through Example 13. In the imaging lenses of Examples 1 through 13, both of the surfaces of all of the first lens L1 through the sixth lens L6 are aspherical surfaces.

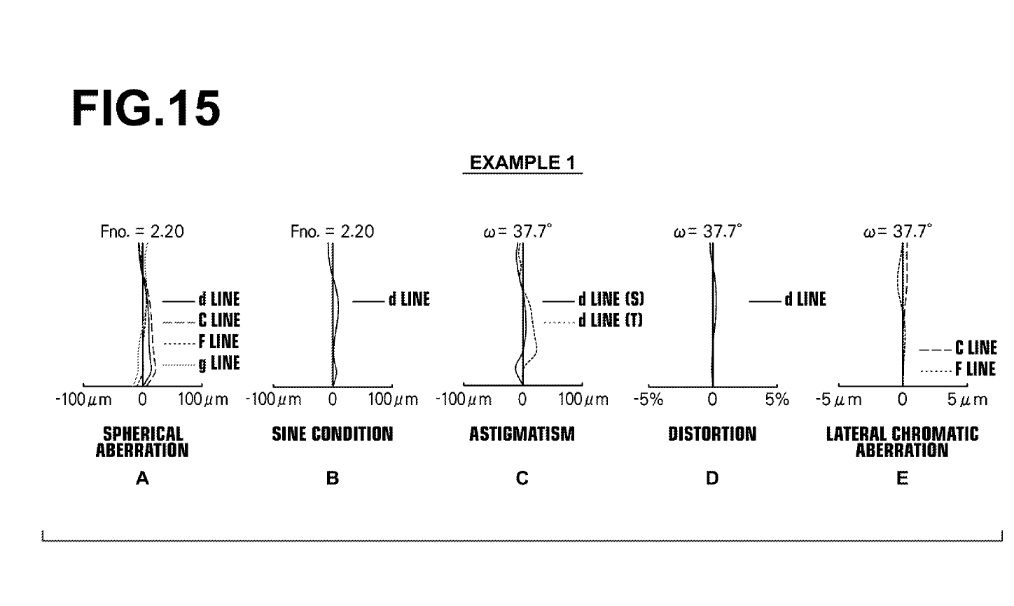

A through E of FIG. 15 are diagrams that illustrate aberrations of the imaging lens of Example 1, wherein the diagrams respectively illustrate spherical aberration, astigmatism, offense of the sine condition (written as “SINE CONDITION” in the figure), distortion, lateral chromatic aberration (chromatic aberration of magnification) of the imaging lens of Example 1. Each of the diagrams that illustrate spherical aberration, offense of the sine condition, astigmatism (field curvature), and distortion illustrate aberrations using the d line (wavelength: 587.56 nm) as a reference wavelength. The diagrams that illustrate spherical aberration and lateral chromatic aberration also show aberrations related to the F line (wavelength: 486.1 nm) and the C line (wavelength: 656.27 nm). In addition, the diagram that illustrates spherical aberration also shows aberration related to the g line (wavelength: 435.83 nm). In the diagram that illustrates astigmatism, aberration in the sagittal direction (S) is indicated by a solid line, while aberration in the tangential direction (T) is indicated by a broken line. In addition, “Fno.” denotes an F number, and “w” denotes a half angle of view.

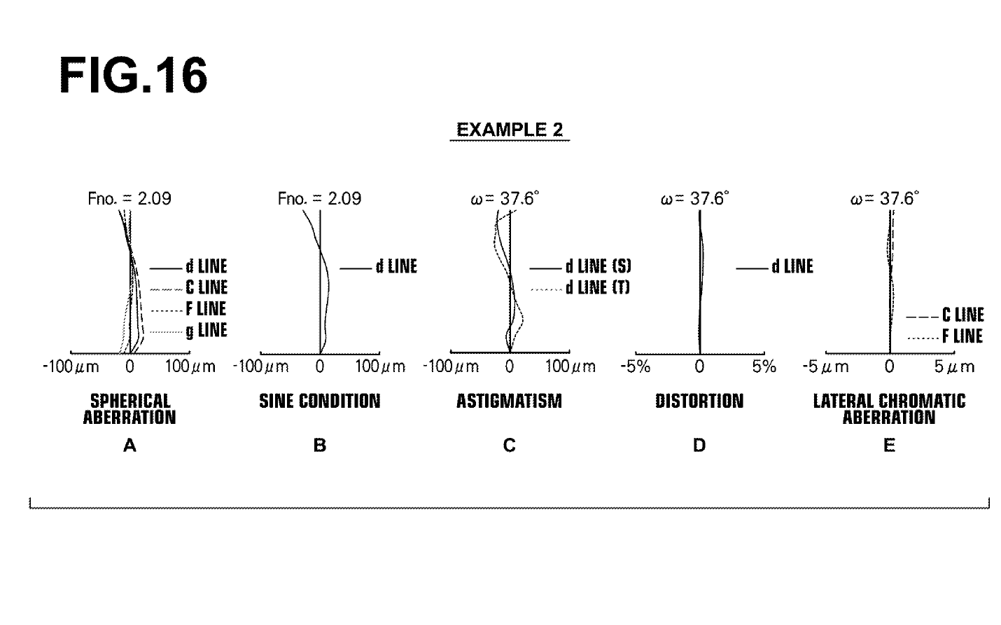

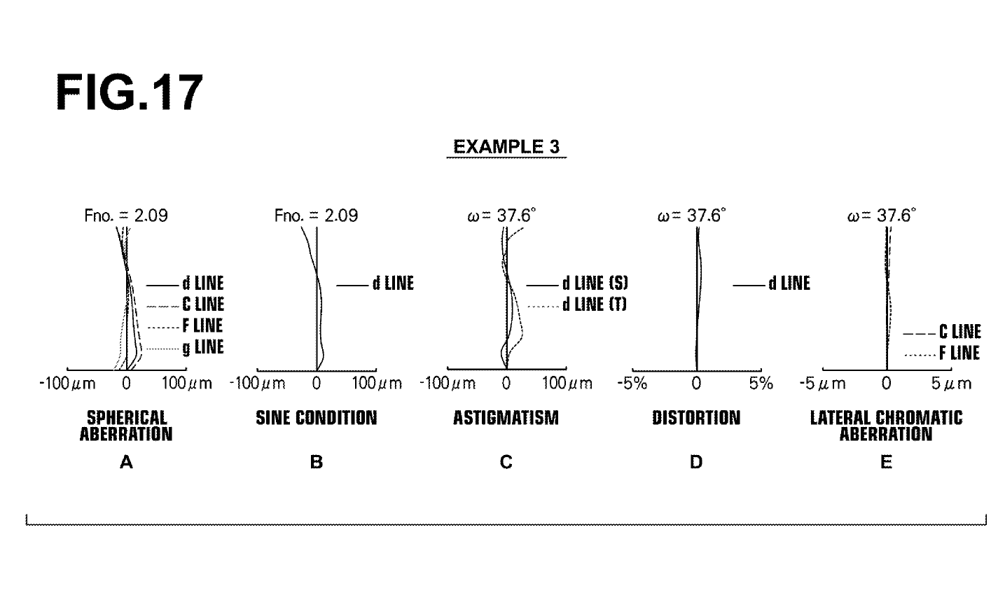

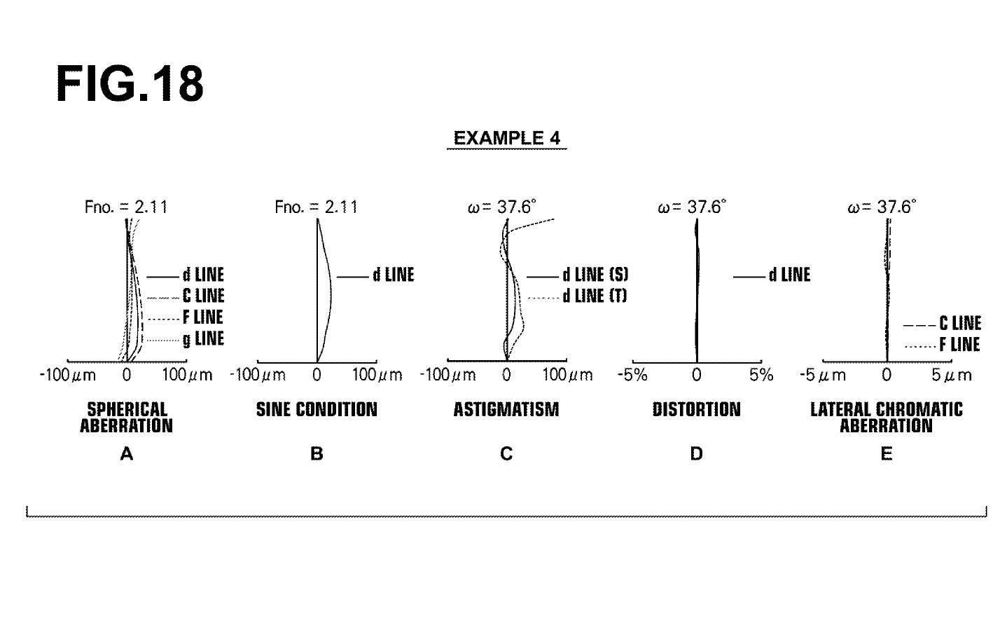

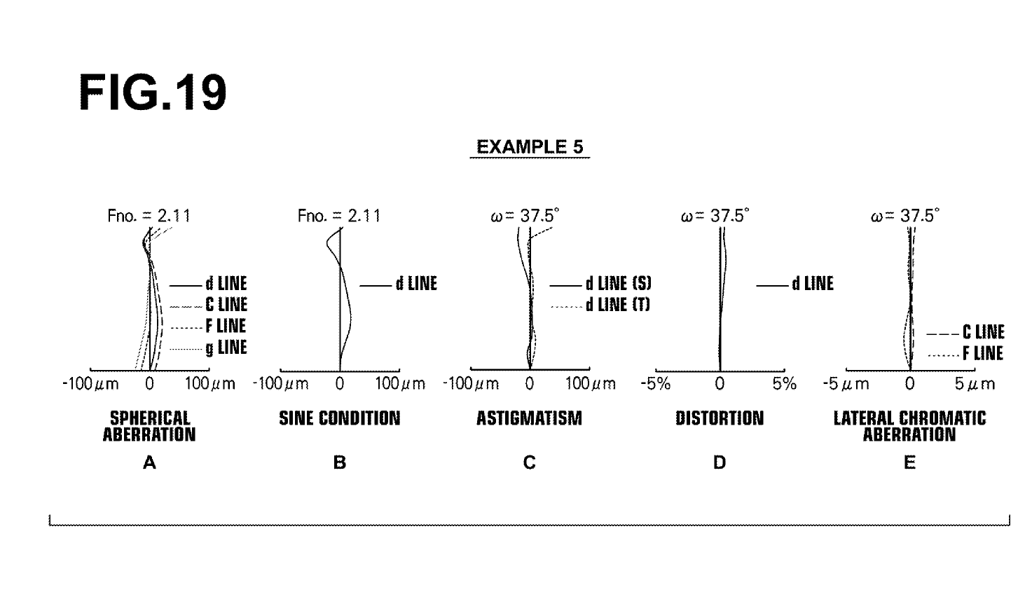

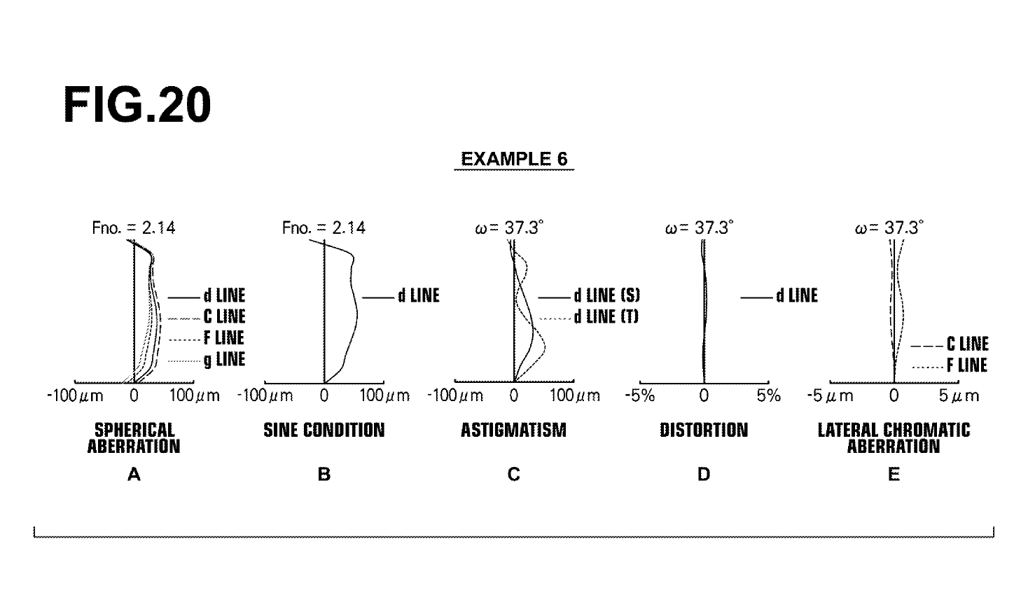

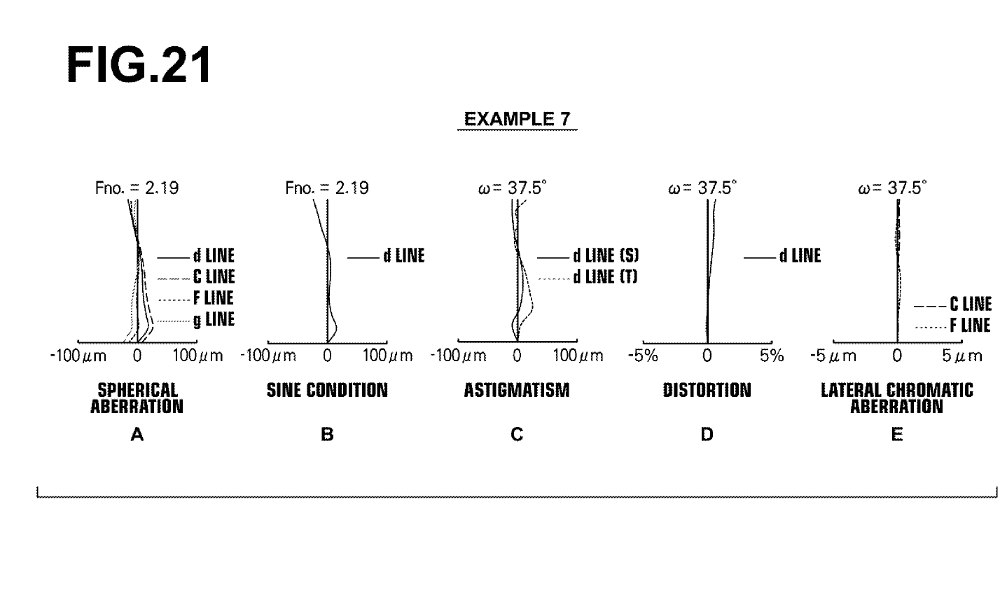

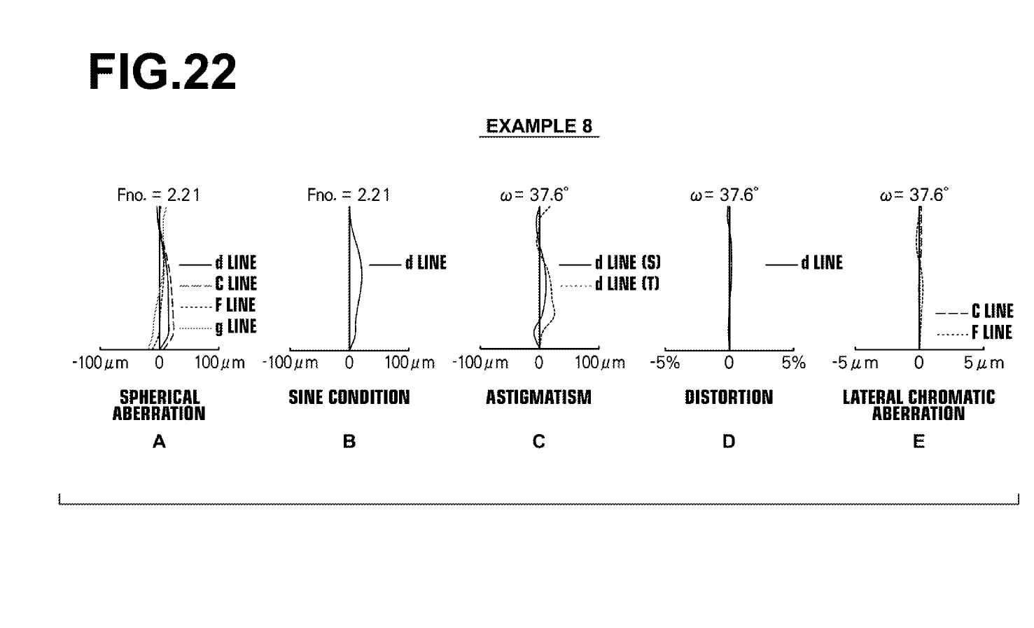

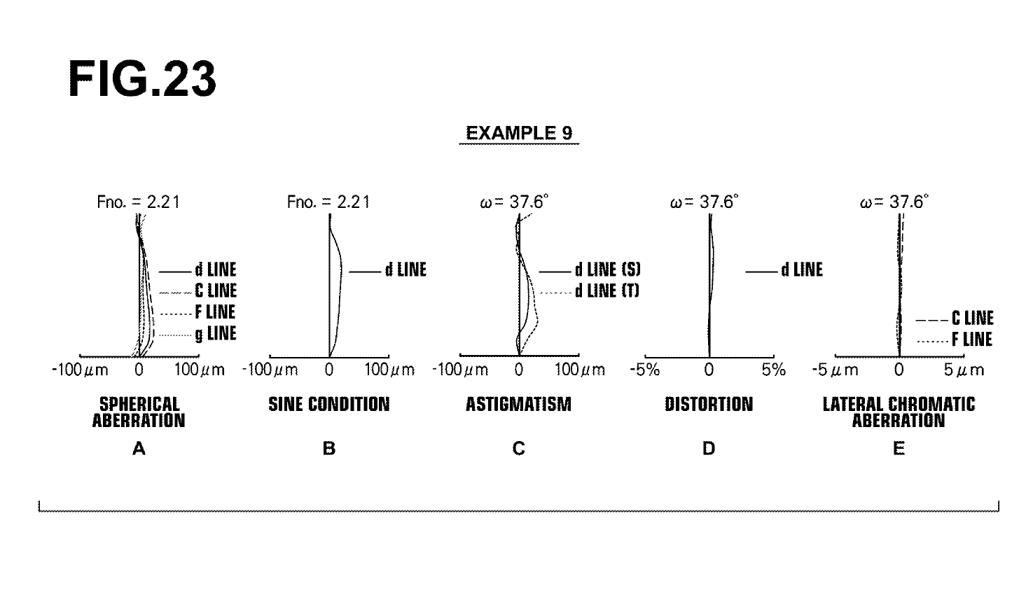

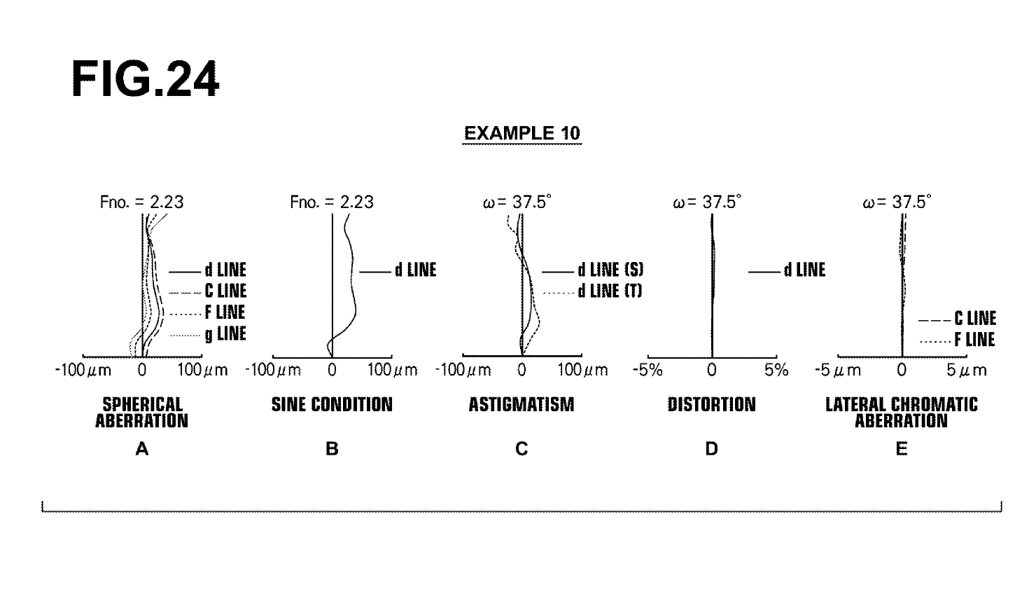

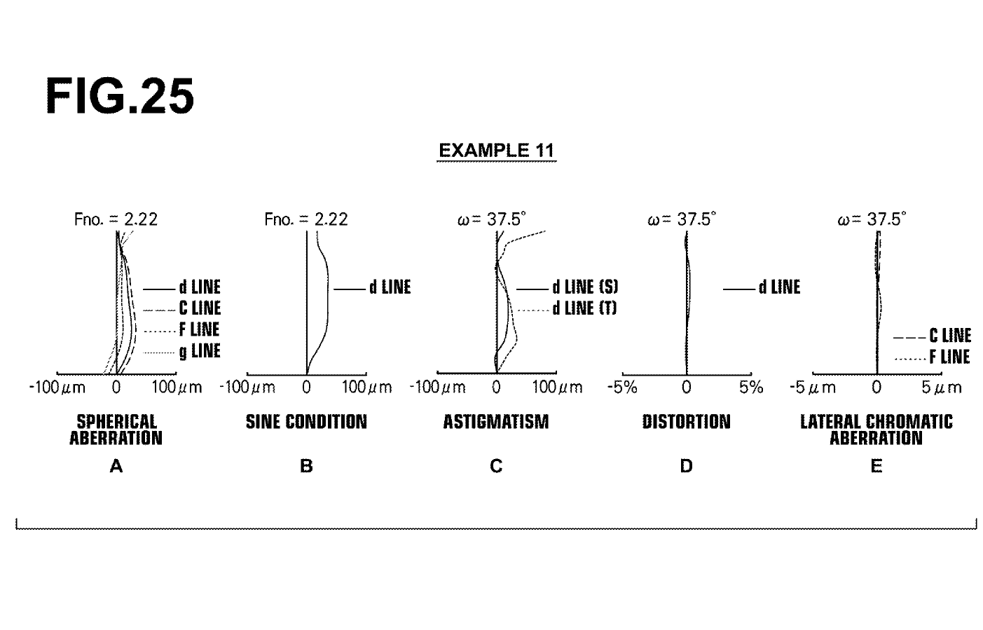

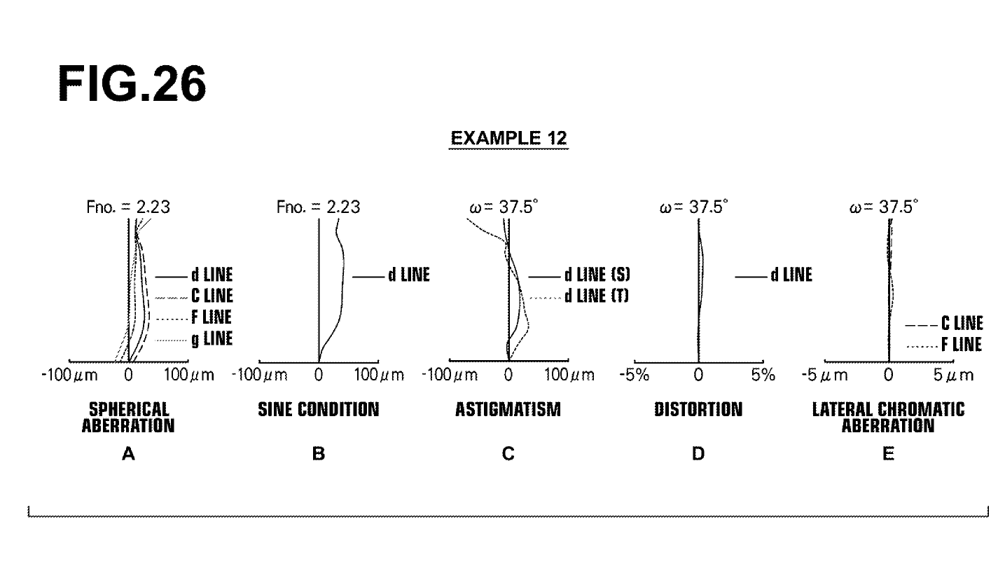

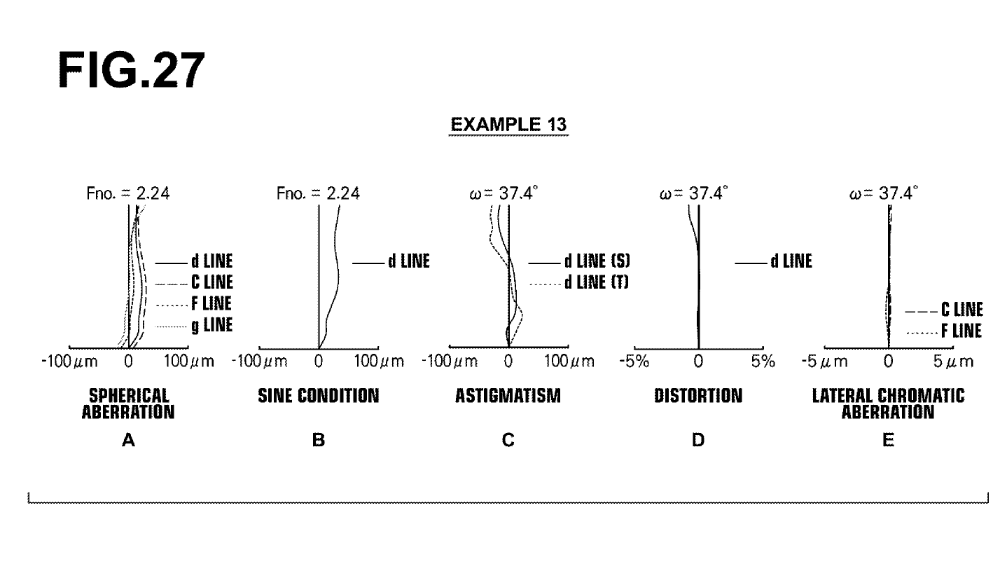

Similarly, various aberrations of the imaging lens of Example 2 are illustrated in A through E of FIG. 16. Similarly, various aberrations of the imaging lenses of Example 3 through Example 13 are illustrated in A through E of FIG. 17 through A through E of FIG. 27.

Table 27 shows values corresponding to Conditional Formulae (1) through (5), respectively summarized for each of Examples 1 through 13.

As can be understood from each set of numerical value data and from the diagrams that illustrate aberrations, each of the Examples realize a shortening of the total length, a small F number, and high imaging performance.

Note that the imaging lens of the present invention is not limited to the embodiments and Examples described above, and various modifications are possible. For example, the values of the radii of curvature, the distances among surfaces, the refractive indices, the Abbe's numbers, the aspherical surface coefficients, etc., are not limited to the numerical values indicated in connection with the Examples of numerical values, and may be other values.

In addition, the Examples are described under the presumption that they are to be utilized with fixed focus. However, it is also possible for configurations capable of adjusting focus to be adopted. It is possible to adopt a configuration, in which the entirety of the lens system is fed out or a portion of the lenses is moved along the optical axis to enable automatic focus, for example.

TABLE 1
Example 1
f = 3.26, Bf = 0.70

| Si | Ri | Di | Ndj | νdj |
|---|---|---|---|---|
| 1 (aperture stop) | ∞ | −0.21 | | |
| *2 | 1.3805 | 0.73 | 1.54492 | 55.89 |
| *3 | 14.4802 | 0.13 | 1.63351 | 23.63 |
| *4 | 3.1828 | 0.27 | | |
| *5 | 6.4068 | 0.39 | 1.54492 | 55.89 |
| *6 | 8.7295 | 0.23 | | |
| *7 | −5.7464 | 0.49 | 1.54492 | 55.89 |
| *8 | −1.3272 | 0.10 | | |
| *9 | −4.2127 | 0.35 | 1.63351 | 23.63 |
| *10 | −9.7803 | 0.16 | | |
| *11 | 4.6374 | 0.45 | 1.54492 | 55.89 |
| *12 | 1.0821 | 0.45 | | |
| 13 | ∞ | 0.11 | 1.51633 | 64.14 |
| 14 | ∞ | 0.17 | | |

*aspherical surface

TABLE 2
Example 1: Aspherical Surface Data

| Surface | | | | | |
|---|---|---|---|---|---|
| Number | KA | A3 | A4 | A5 | A6 |
| 2 | 1.0255594E+00 | −4.0852963E−02 | 2.5979114E−01 | −1.0058307E+00 | 2.7080859E+00 |
| 3 | 4.9510495E+01 | 5.9645822E−01 | −4.7798940E+00 | 1.5240901E+01 | −2.6473278E+01 |
| 4 | −4.0307806E+01 | 1.5194500E−01 | −1.0558739E+00 | 4.5641641E+00 | −1.0991545E+01 |
| 5 | −1.6127606E+01 | −3.2675579E−02 | 2.2066819E−01 | −2.0360538E+00 | 4.7126756E+00 |
| 6 | −4.5702513E+01 | −2.0580958E−01 | 1.5345093E+00 | −7.8184198E+00 | 2.1963774E+01 |
| 7 | −3.8459537E+00 | 1.9057658E−02 | −3.4373564E−01 | 1.2335930E+00 | −2.7043648E+00 |
| 8 | −6.1532473E+00 | 7.7249931E−02 | −6.0038798E−01 | −1.3801008E−01 | 2.4299745E+00 |
| 9 | −1.1614411E+01 | 1.4599916E−01 | −4.0989636E−01 | 5.1907790E−02 | 1.4080138E−01 |
| 10 | 1.2804644E+00 | 1.1717377E−01 | −2.0375234E−01 | −1.9561043E−01 | 1.5589739E−01 |
| 11 | −5.0000000E+01 | 1.0557487E−01 | −9.7919435E−01 | 8.0837226E−01 | −4.7888643E−02 |
| 12 | −6.9904281E+00 | 1.4499521E−01 | −7.0795315E−01 | 8.1056702E−01 | −3.7968039E−01 |
| | A7 | A8 | A9 | A10 | |
| 2 | −5.0074153E+00 | 6.0298189E+00 | −4.1995242E+00 | 1.2804419E+00 | |
| 3 | 1.8848672E+01 | 1.2293573E+01 | −2.8638415E+01 | 1.2730888E+01 | |
| 4 | 1.6504022E+01 | −1.5550703E+01 | 8.9151031E+00 | −2.5423556E+00 | |
| 5 | −3.0427892E+00 | −5.9784266E+00 | 1.0825728E+01 | −4.9585658E+00 | |
| 6 | −3.8019888E+01 | 4.0240668E+01 | −2.4522067E+01 | 6.6453247E+00 | |
| 7 | 3.1697719E+00 | −1.1053656E+00 | −1.1373310E+00 | 7.5053980E−01 | |
| 8 | −4.3134766E+00 | 4.1169469E+00 | −2.1121275E+00 | 4.4365538E−01 | |
| 9 | −1.1191798E−01 | 6.2992136E−03 | 1.1255061E−01 | −5.6751064E−02 | |
| 10 | 7.4236566E−02 | −3.4285679E−02 | −1.9049029E−02 | 7.3043537E−03 | |
| 11 | −2.1729491E−01 | 1.2546369E−01 | −3.1080407E−02 | 2.9642830E−03 | |
| 12 | −7.5708202E−03 | 8.5015305E−02 | −3.4744429E−02 | 4.7595170E−03 | |

TABLE 3
Example 2
f = 3.26, Bf = 0.69

| Si | Ri | Di | Ndj | νdj |
|---|---|---|---|---|
| 1 (aperture stop) | ∞ | −0.21 | | |
| *2 | 1.3466 | 0.71 | 1.54492 | 55.89 |
| *3 | 14.1917 | 0.13 | 1.63351 | 23.63 |
| *4 | 3.0280 | 0.27 | | |
| *5 | 6.2602 | 0.40 | 1.54492 | 55.89 |
| *6 | 8.8918 | 0.24 | | |
| *7 | −5.4616 | 0.42 | 1.54492 | 55.89 |
| *8 | −1.5066 | 0.13 | | |
| *9 | −8.0137 | 0.34 | 1.63351 | 23.63 |
| *10 | −71.9605 | 0.17 | | |
| *11 | 3.0437 | 0.41 | 1.54492 | 55.89 |
| *12 | 0.9923 | 0.45 | | |
| 13 | ∞ | 0.11 | 1.51633 | 64.14 |
| 14 | ∞ | 0.17 | | |

*aspherical surface

TABLE 4
Example 2: Aspherical Surface Data

| Surface | | | | | |
|---|---|---|---|---|---|
| Number | KA | A3 | A4 | A5 | A6 |
| 2 | 1.0495762E+00 | −3.6996655E−02 | 2.3381522E−01 | −9.2171854E−01 | 2.5492370E+00 |
| 3 | 4.1470237E+01 | 6.7332645E−01 | −5.1487264E+00 | 1.5856384E+01 | −2.6228730E+01 |
| 4 | −4.0262733E+01 | 1.5899850E−01 | −1.0727059E+00 | 4.6702792E+00 | −1.1097088E+01 |
| 5 | −1.5217379E+01 | −3.4680453E−02 | 2.3102187E−01 | −1.9907296E+00 | 4.5918910E+00 |
| 6 | −4.5737141E+01 | −2.1040714E−01 | 1.5508834E+00 | −7.7865514E+00 | 2.1881072E+01 |
| 7 | −3.6888902E+00 | 3.2416243E−03 | −3.1041509E−01 | 1.2650408E+00 | −2.7402542E+00 |
| 8 | −6.2710139E+00 | 7.3060613E−02 | −5.6299529E−01 | −1.3564310E−01 | 2.4239396E+00 |
| 9 | −1.1525960E+01 | 1.2951263E−01 | −4.0955756E−01 | 4.7188497E−02 | 1.3167710E−01 |
| 10 | 1.8552719E+00 | 1.0880546E−01 | −2.1687873E−01 | −1.9876925E−01 | 1.5705506E−01 |
| 11 | −4.9985023E+01 | 8.8513681E−02 | −9.7617003E−01 | 8.1281594E−01 | −4.6837803E−02 |
| 12 | −6.7021499E+00 | 1.0787598E−01 | −6.9510186E−01 | 8.1449852E−01 | −3.7955579E−01 |
| | A7 | A8 | A9 | A10 | |
| 2 | −4.8176802E+00 | 5.8741787E+00 | −4.1211271E+00 | 1.2664986E+00 | |
| 3 | 1.7238003E+01 | 1.2749134E+01 | −2.6487993E+01 | 1.1071723E+01 | |
| 4 | 1.6423090E+01 | −1.5525300E+01 | 9.2898137E+00 | −2.8508268E+00 | |
| 5 | −3.0413676E+00 | −5.9115141E+00 | 1.1067814E+01 | −5.2113031E+00 | |
| 6 | −3.8048355E+01 | 4.0314554E+01 | −2.4522067E+01 | 6.6453247E+00 | |
| 7 | 3.1349495E+00 | −1.1146165E+00 | −1.1050277E+00 | 7.4588648E−01 | |
| 8 | −4.3178060E+00 | 4.1094479E+00 | −2.1130075E+00 | 4.4728096E−01 | |
| 9 | −1.0941606E−01 | 1.3533224E−02 | 1.1328392E−01 | −5.8932878E−02 | |
| 10 | 7.4493653E−02 | −3.3650598E−02 | −1.8333776E−02 | 6.8849098E−03 | |
| 11 | −2.1762557E−01 | 1.2499165E−01 | −3.1460201E−02 | 3.1694306E−03 | |
| 12 | −8.0253460E−03 | 8.4413080E−02 | −3.4864214E−02 | 4.8943019E−03 | |

TABLE 5
Example 3
f = 3.25, Bf = 0.66

| Si | Ri | Di | Ndj | νdj |
|---|---|---|---|---|
| 1 (aperture stop) | ∞ | −0.21 | | |
| *2 | 1.3251 | 0.67 | 1.54492 | 55.89 |
| *3 | 9.5497 | 0.13 | 1.63351 | 23.63 |
| *4 | 2.9712 | 0.28 | | |
| *5 | 7.0585 | 0.40 | 1.54492 | 55.89 |
| *6 | 11.0300 | 0.25 | | |
| *7 | −4.8386 | 0.40 | 1.54492 | 55.89 |
| *8 | −1.3532 | 0.15 | | |
| *9 | −4.6287 | 0.33 | 1.63351 | 23.63 |
| *10 | −9.6191 | 0.18 | | |
| *11 | 8.2284 | 0.42 | 1.54492 | 55.89 |
| *12 | 1.1734 | 0.45 | | |
| 13 | ∞ | 0.11 | 1.51633 | 64.14 |
| 14 | ∞ | 0.14 | | |

*aspherical surface

TABLE 6
Example 3: Aspherical Surface Data

| Surface | | | | | |
|---|---|---|---|---|---|
| Number | KA | A3 | A4 | A5 | A6 |
| 2 | 1.0734190E+00 | −4.1631337E−02 | 2.5407757E−01 | −9.7372318E−01 | 2.6487994E+00 |
| 3 | 4.9679635E+01 | 5.7575748E−01 | −4.7540308E+00 | 1.5060138E+01 | −2.5833156E+01 |
| 4 | −3.9045840E+01 | 1.4361623E−01 | −1.0199310E+00 | 4.6602609E+00 | −1.1307466E+01 |
| 5 | −1.3933351E+01 | −3.8443434E−02 | 2.3510694E−01 | −1.9529576E+00 | 4.4741530E+00 |
| 6 | −5.0000009E+01 | −2.0410244E−01 | 1.5580608E+00 | −7.8290911E+00 | 2.1891178E+01 |
| 7 | 5.9133157E−01 | 3.2001209E−02 | −3.3307360E−01 | 1.2194598E+00 | −2.7126375E+00 |
| 8 | −6.2528076E+00 | 8.1597825E−02 | −5.7427888E−01 | −1.3373367E−01 | 2.4213667E+00 |
| 9 | −1.1380124E+01 | 1.3384254E−01 | −4.0193992E−01 | 4.6108045E−02 | 1.4130760E−01 |
| 10 | 4.4988451E−01 | 1.2132379E−01 | −1.9938521E−01 | −1.9810020E−01 | 1.5301894E−01 |
| 11 | −4.9575275E+01 | 1.1200977E−01 | −9.8168999E−01 | 8.0806623E−01 | −4.7250021E−02 |
| 12 | −7.5646980E+00 | 1.2529025E−01 | −7.0680900E−01 | 8.1578025E−01 | −3.7901022E−01 |
| | A7 | A8 | A9 | A10 | |
| 2 | −4.9817488E+00 | 6.0809833E+00 | −4.2894790E+00 | 1.3334595E+00 | |
| 3 | 1.8027174E+01 | 1.2257731E+01 | −2.7282908E+01 | 1.1575475E+01 | |
| 4 | 1.6773684E+01 | −1.5564156E+01 | 9.0878955E+00 | −2.7850789E+00 | |
| 5 | −3.0371103E+00 | −5.6743164E+00 | 1.0971833E+01 | −5.2805418E+00 | |
| 6 | −3.8020036E+01 | 4.0316624E+01 | −2.4522067E+01 | 6.6453247E+00 | |
| 7 | 3.1628192E+00 | −1.1094717E+00 | −1.1531085E+00 | 7.6917102E−01 | |
| 8 | −4.3273160E+00 | 4.1167162E+00 | −2.1046135E+00 | 4.4252795E−01 | |
| 9 | −1.1117206E−01 | 5.9430698E−03 | 1.1201794E−01 | −5.6437838E−02 | |
| 10 | 7.3249688E−02 | −3.3758282E−02 | −1.8485565E−02 | 7.1738759E−03 | |
| 11 | −2.1722799E−01 | 1.2528436E−01 | −3.1278980E−02 | 3.0553560E−03 | |
| 12 | −8.5615228E−03 | 8.4643987E−02 | −3.4821590E−02 | 4.8572252E−03 | |

TABLE 7
Example 4
f = 3.26, Bf = 0.68

| Si | Ri | Di | Ndj | νdj |
|---|---|---|---|---|
| 1 (aperture stop) | ∞ | −0.21 | | |
| *2 | 1.3555 | 0.60 | 1.54001 | 55.00 |
| *3 | 13.8554 | 0.27 | 1.63351 | 23.63 |
| *4 | 2.8341 | 0.26 | | |
| *5 | 4.2115 | 0.40 | 1.54492 | 55.89 |
| *6 | 7.1677 | 0.25 | | |
| *7 | −4.3795 | 0.42 | 1.54492 | 55.89 |
| *8 | −1.5665 | 0.10 | | |
| *9 | 13.1576 | 0.34 | 1.63351 | 23.63 |
| *10 | 4.9493 | 0.21 | | |
| *11 | 2.5941 | 0.38 | 1.54492 | 55.89 |
| *12 | 1.0012 | 0.45 | | |
| 13 | ∞ | 0.11 | 1.51633 | 64.14 |
| 14 | ∞ | 0.16 | | |

*aspherical surface

TABLE 8
Example 4: Aspherical Surface Data

| Surface | | | | | |
|---|---|---|---|---|---|
| Number | KA | A3 | A4 | A5 | A6 |
| 2 | 3.6289907E−01 | −7.3866518E−02 | 5.3512039E−01 | −1.9227557E+00 | 4.6914873E+00 |
| 3 | 1.2267520E+01 | 5.0886010E−01 | −4.2725402E+00 | 1.5361859E+01 | −3.0506873E+01 |
| 4 | −4.0746184E+01 | 5.4937496E−02 | −2.4502376E−01 | 1.8135949E+00 | −5.7904883E+00 |
| 5 | −6.8930506E+00 | −8.4142400E−02 | 5.4869926E−01 | −2.9540246E+00 | 6.1428303E+00 |
| 6 | 2.3383167E+01 | −2.2298778E−01 | 1.6802799E+00 | −8.1560704E+00 | 2.2373562E+01 |
| 7 | −9.1540454E+00 | 1.3250591E−03 | −1.9994660E−01 | 1.2318977E+00 | −3.1213081E+00 |
| 8 | −6.8931179E+00 | 1.6969365E−01 | −6.8710303E−01 | −2.2310535E−01 | 2.5004636E+00 |
| 9 | −3.6664168E−01 | 2.2931385E−01 | −6.7602800E−01 | 8.5655832E−02 | 1.9529282E−01 |
| 10 | 9.7423620E−01 | 7.5197057E−02 | −2.5317546E−01 | −2.2613905E−01 | 1.8680140E−01 |
| 11 | −4.9968520E+01 | 2.2349182E−02 | −8.9619351E−01 | 8.1572113E−01 | −6.5109048E−02 |
| 12 | −8.1269220E+00 | 1.0880492E−01 | −7.1150129E−01 | 8.3275724E−01 | −3.8104516E−01 |
| | A7 | A8 | A9 | A10 | |
| 2 | −7.3964970E+00 | 7.4877975E+00 | −4.4706050E+00 | 1.2226361E+00 | |
| 3 | 2.7561479E+01 | 3.1547310E+00 | −2.3320165E+01 | 1.1452374E+01 | |
| 4 | 1.1500740E+01 | −1.4734865E+01 | 1.1300678E+01 | −3.8974453E+00 | |
| 5 | −4.0953747E+00 | −6.0401188E+00 | 1.1454423E+01 | −5.2663567E+00 | |
| 6 | −3.8358927E+01 | 4.0363977E+01 | −2.4522067E+01 | 6.6453247E+00 | |
| 7 | 3.5595014E+00 | −7.7150830E−01 | −1.8475270E+00 | 1.0421664E+00 | |
| 8 | −4.1574575E+00 | 4.0504045E+00 | −2.2310788E+00 | 5.0602227E−01 | |
| 9 | −9.7376597E−02 | −6.1739131E−04 | 1.1654343E−01 | −6.2277738E−02 | |
| 10 | 8.2968098E−02 | −3.4334254E−02 | −2.5808646E−02 | 9.1618066E−03 | |
| 11 | −2.2454079E−01 | 1.2897028E−01 | −2.9753752E−02 | 2.5054312E−03 | |
| 12 | −1.0483548E−02 | 8.3607004E−02 | −3.4212499E−02 | 4.8488002E−03 | |

TABLE 9
Example 5
f = 3.26, Bf = 0.63

| Si | Ri | Di | Ndj | νdj |
|---|---|---|---|---|
| 1 (aperture stop) | ∞ | −0.21 | | |
| *2 | 1.3325 | 0.61 | 1.52866 | 55.00 |
| *3 | 23.1789 | 0.28 | 1.63351 | 23.63 |
| *4 | 3.2054 | 0.26 | | |
| *5 | 5.8267 | 0.40 | 1.54492 | 55.89 |
| *6 | 8.7921 | 0.24 | | |
| *7 | −5.2767 | 0.42 | 1.54492 | 55.89 |
| *8 | −2.4017 | 0.10 | | |
| *9 | 3.1465 | 0.34 | 1.63351 | 23.63 |
| *10 | 3.3036 | 0.23 | | |
| *11 | 3.1329 | 0.41 | 1.54492 | 55.89 |
| *12 | 1.0682 | 0.45 | | |
| 13 | ∞ | 0.11 | 1.51633 | 64.14 |
| 14 | ∞ | 0.10 | | |

*aspherical surface

TABLE 10
Example 5: Aspherical Surface Data

| Surface | | | | | |
|---|---|---|---|---|---|
| Number | KA | A3 | A4 | A5 | A6 |
| 2 | 4.1460782E−02 | −2.8672514E−02 | 3.2398825E−01 | −1.3940451E+00 | 4.2819965E+00 |
| 3 | −2.8087680E+01 | 1.3331472E−01 | −1.8494157E+00 | 8.2838246E+00 | −2.0229606E+01 |
| 4 | −4.2464590E+01 | 3.1557943E−02 | −1.7208246E−01 | 1.6426626E+00 | −5.6204786E+00 |
| 5 | 1.2660285E+00 | −6.7270456E−02 | 4.3738097E−01 | −2.6044217E+00 | 5.4913707E+00 |
| 6 | −9.1548335E+00 | −1.6366824E−01 | 1.4710254E+00 | −7.7481158E+00 | 2.1894880E+01 |
| 7 | −1.4775040E+01 | 2.7047107E−02 | −1.4479256E−01 | 9.4064006E−01 | −2.7905476E+00 |
| 8 | −7.3699745E+00 | 1.2521511E−01 | −6.6868189E−01 | −2.0228903E−01 | 2.4047948E+00 |
| 9 | −4.1252524E−01 | 1.1080818E−01 | −6.9043243E−01 | 4.0616747E−02 | 2.7402724E−01 |
| 10 | 1.0042399E+00 | 8.7631976E−03 | −2.3293838E−01 | −2.2790090E−01 | 1.8052903E−01 |
| 11 | −4.9999998E+01 | 2.8994400E−02 | −9.2595956E−01 | 8.2386585E−01 | −6.1814655E−02 |
| 12 | −6.7231126E+00 | 8.4176313E−02 | −6.8995637E−01 | 8.2387961E−01 | −3.7984309E−01 |
| | A7 | A8 | A9 | A10 | |
| 2 | −7.7367261E+00 | 8.1150401E+00 | −4.4861539E+00 | 1.0239178E+00 | |
| 3 | 2.4265998E+01 | −8.6351262E+00 | −6.8837799E+00 | 4.7003452E+00 | |
| 4 | 1.1402211E+01 | −1.4588357E+01 | 1.1106924E+01 | −3.8040319E+00 | |
| 5 | −3.7270467E+00 | −5.5625783E+00 | 1.0720088E+01 | −4.9947923E+00 | |
| 6 | −3.8043957E+01 | 4.0305860E+01 | −2.4522067E+01 | 6.6453247E+00 | |
| 7 | 3.3744019E+00 | −8.7210295E−01 | −1.5239492E+00 | 8.8035963E−01 | |
| 8 | −4.1133527E+00 | 4.0682847E+00 | −2.2161645E+00 | 4.9020357E−01 | |
| 9 | −7.7795199E−02 | −2.5491816E−02 | 9.9407401E−02 | −5.1466328E−02 | |
| 10 | 8.2127698E−02 | −3.1389024E−02 | −2.4871888E−02 | 8.4252817E−03 | |
| 11 | −2.2442251E−01 | 1.2919816E−01 | −3.0083417E−02 | 2.5062268E−03 | |
| 12 | −1.0069087E−02 | 8.3663599E−02 | −3.4110111E−02 | 4.7593944E−03 | |

TABLE 11
Example 6
f = 3.30, Bf = 0.69

| Si | Ri | Di | Ndj | νdj |
|---|---|---|---|---|
| *1 | 1.2231 | 0.66 | 1.54492 | 55.89 |
| *2 | 16.0165 | 0.13 | 1.63351 | 23.63 |
| *3 (aperture stop) | 2.9853 | 0.32 | | |
| *4 | −16.5214 | 0.39 | 1.54492 | 55.89 |
| *5 | −8.3531 | 0.24 | | |
| *6 | −2.7420 | 0.40 | 1.54492 | 55.89 |
| *7 | −1.3572 | 0.10 | | |
| *8 | −5.5876 | 0.39 | 1.63351 | 23.63 |
| *9 | −7.8577 | 0.16 | | |
| *10 | 5.3567 | 0.39 | 1.54492 | 55.89 |
| *11 | 1.1427 | 0.45 | | |
| 12 | ∞ | 0.11 | 1.51633 | 64.14 |
| 13 | ∞ | 0.17 | | |

*aspherical surface

TABLE 12
Example 6: Aspherical Surface Data

| Surface | | | | | |
|---|---|---|---|---|---|
| Number | KA | A3 | A4 | A5 | A6 |
| 1 | 8.7941461E−01 | −5.6299774E−02 | 3.1085712E−01 | −1.0323478E+00 | 2.6999494E+00 |
| 2 | 4.8755260E+01 | 2.6693101E−01 | −2.8548288E+00 | 1.2007610E+01 | −2.5888311E+01 |
| 3 | −3.9013565E+01 | 5.3104145E−02 | −5.2250354E−01 | 4.1038957E+00 | −1.1898826E+01 |
| 4 | −1.4073583E+01 | −5.7130306E−02 | 3.3523357E−01 | −2.1471792E+00 | 4.4334318E+00 |
| 5 | −5.0000007E+01 | −1.5879228E−01 | 1.3539614E+00 | −7.5658827E+00 | 2.2011239E+01 |
| 6 | 5.9979267E−01 | 1.9802689E−02 | −3.2403606E−01 | 1.1995528E+00 | −2.7196745E+00 |
| 7 | −6.0656138E+00 | 4.7309121E−02 | −5.8680938E−01 | −1.3117792E−01 | 2.3993054E+00 |
| 8 | −1.1515210E+01 | 1.1257054E−01 | −4.0981430E−01 | 5.5371529E−02 | 1.5261187E−01 |
| 9 | 5.1697333E−01 | 1.1036397E−01 | −1.7854811E−01 | −2.0733826E−01 | 1.4633352E−01 |
| 10 | −4.9595571E+01 | 8.9835038E−02 | −9.8054683E−01 | 8.1211933E−01 | −4.5850734E−02 |
| 11 | −7.6646728E+00 | 1.1015545E−01 | −7.0535971E−01 | 8.1681755E−01 | −3.7874849E−01 |
| | A7 | A8 | A9 | A10 | |
| 1 | −4.9698685E+00 | 6.0756321E+00 | −4.3104585E+00 | 1.3693053E+00 | |
| 2 | 2.2559015E+01 | 1.0008085E+01 | −3.1751968E+01 | 1.6095207E+01 | |
| 3 | 1.7548225E+01 | −1.3417832E+01 | 5.9289636E+00 | −1.9122411E+00 | |
| 4 | −3.2758908E+00 | −3.9130446E+00 | 8.4101211E+00 | −4.2961432E+00 | |
| 5 | −3.8640597E+01 | 4.0699150E+01 | −2.4522067E+01 | 6.6453247E+00 | |
| 6 | 3.1766369E+00 | −1.1264129E+00 | −1.2253717E+00 | 8.5082601E−01 | |
| 7 | −4.3336834E+00 | 4.1361142E+00 | −2.0775692E+00 | 4.2376661E−01 | |
| 8 | −1.0687994E−01 | 2.3151918E−03 | 1.0623821E−01 | −5.3695461E−02 | |
| 9 | 7.3690373E−02 | −3.0982245E−02 | −1.6993343E−02 | 6.0962932E−03 | |
| 10 | −2.1720583E−01 | 1.2459100E−01 | −3.1610487E−02 | 3.2637287E−03 | |
| 11 | −8.9343964E−03 | 8.4366749E−02 | −3.4930260E−02 | 4.9524066E−03 | |

TABLE 13
Example 7
f = 3.25, Bf = 0.65

| Si | Ri | Di | Ndj | νdj |
|---|---|---|---|---|
| 1 (aperture stop) | ∞ | −0.21 | | |
| *2 | 1.3346 | 0.69 | 1.54492 | 55.89 |
| *3 | 79.2189 | 0.13 | 1.60000 | 28.43 |
| *4 | 3.0023 | 0.27 | | |
| *5 | 6.7347 | 0.40 | 1.54492 | 55.89 |
| *6 | 10.3958 | 0.26 | | |
| *7 | −4.7729 | 0.39 | 1.54492 | 55.89 |
| *8 | −1.3827 | 0.14 | | |
| *9 | −5.0998 | 0.34 | 1.63351 | 23.63 |
| *10 | −10.3436 | 0.18 | | |
| *11 | 8.5488 | 0.42 | 1.54492 | 55.89 |
| *12 | 1.1798 | 0.45 | | |
| 13 | ∞ | 0.11 | 1.51633 | 64.14 |
| 14 | ∞ | 0.13 | | |

*aspherical surface

TABLE 14
Example 7: Aspherical Surface Data

| Surface | | | | | |
|---|---|---|---|---|---|
| Number | K | A3 | A4 | A5 | A6 |
| 2 | 1.0697161E+00 | −3.7551754E−02 | 2.4019086E−01 | −9.6147515E−01 | 2.6535904E+00 |
| 3 | 3.5204553E+01 | 5.5013416E−01 | −5.1977570E+00 | 1.5841683E+01 | −2.5829938E+01 |
| 4 | −3.9044461E+01 | 1.3346311E−01 | −1.0149149E+00 | 4.6666188E+00 | −1.1291256E+01 |
| 5 | −1.3920186E+01 | −3.6396421E−02 | 2.2176496E−01 | −1.9289823E+00 | 4.4674217E+00 |
| 6 | −5.0000009E+01 | −2.0640554E−01 | 1.5613334E+00 | −7.8268711E+00 | 2.1889967E+01 |
| 7 | 5.9065058E−01 | 3.2626918E−02 | −3.4090325E−01 | 1.2299609E+00 | −2.7152801E+00 |
| 8 | −6.3216834E+00 | 8.0039476E−02 | −5.6871552E−01 | −1.4012384E−01 | 2.4210419E+00 |
| 9 | −1.1380311E+01 | 1.2810285E−01 | −4.0390081E−01 | 4.8963587E−02 | 1.4196854E−01 |
| 10 | 4.4633560E−01 | 1.1732687E−01 | −2.0075217E−01 | −1.9849034E−01 | 1.5345838E−01 |
| 11 | −4.9575532E+01 | 1.0952471E−01 | −9.8171004E−01 | 8.0868413E−01 | −4.6991060E−02 |
| 12 | −7.5448781E+00 | 1.2243420E−01 | −7.0487790E−01 | 8.1613457E−01 | −3.7909643E−01 |
| | A7 | A8 | A9 | A10 | |
| 2 | −4.9818835E+00 | 6.0570863E+00 | −4.2715745E+00 | 1.3295900E+00 | |
| 3 | 1.7651869E+01 | 1.1961708E+01 | −2.7222332E+01 | 1.1868861E+01 | |
| 4 | 1.6713281E+01 | −1.5586436E+01 | 9.1483752E+00 | −2.7878395E+00 | |
| 5 | −3.0805296E+00 | −5.6607085E+00 | 1.1064098E+01 | −5.3757930E+00 | |
| 6 | −3.8023061E+01 | 4.0324200E+01 | −2.4522067E+01 | 6.6453247E+00 | |
| 7 | 3.1567496E+00 | −1.1065927E+00 | −1.1466960E+00 | 7.6491566E−01 | |
| 8 | −4.3256766E+00 | 4.1182785E+00 | −2.1058851E+00 | 4.4254955E−01 | |
| 9 | −1.1107245E−01 | 6.0454348E−03 | 1.1207079E−01 | −5.6743175E−02 | |
| 10 | 7.3546711E−02 | −3.3471866E−02 | −1.8470997E−02 | 7.0720891E−03 | |
| 11 | −2.1719082E−01 | 1.2525440E−01 | −3.1300128E−02 | 3.0502679E−03 | |
| 12 | −8.6536617E−03 | 8.4601088E−02 | −3.4824965E−02 | 4.8649988E−03 | |

TABLE 15
Example 8
f = 3.26, Bf = 0.69

| Si | Ri | Di | Ndj | νdj |
|---|---|---|---|---|
| 1 (aperture stop) | ∞ | −0.21 | | |
| *2 | 1.3175 | 0.70 | 1.52866 | 55.00 |
| *3 | −54.4779 | 0.14 | 1.60000 | 28.43 |
| *4 | 2.9383 | 0.26 | | |
| *5 | 4.8177 | 0.39 | 1.54492 | 55.89 |
| *6 | 7.7173 | 0.26 | | |
| *7 | −4.2631 | 0.39 | 1.54492 | 55.89 |
| *8 | −1.3708 | 0.10 | | |
| *9 | −10.5616 | 0.34 | 1.63351 | 23.63 |
| *10 | 12.1426 | 0.21 | | |
| *11 | 2.6840 | 0.39 | 1.54492 | 55.89 |
| *12 | 0.9763 | 0.45 | | |
| 13 | ∞ | 0.11 | 1.51633 | 64.14 |
| 14 | ∞ | 0.16 | | |

*aspherical surface

TABLE 16
Example 8: Aspherical Surface Data

| Surface | | | | | |
|---|---|---|---|---|---|
| Number | K | A3 | A4 | A5 | A6 |
| 2 | 9.6140958E−01 | −5.2173613E−02 | 3.2154930E−01 | −1.1262575E+00 | 2.6760529E+00 |
| 3 | −4.8976438E+01 | 9.0498707E−01 | −7.1725012E+00 | 2.1820795E+01 | −3.6073275E+01 |
| 4 | −4.2854720E+01 | 1.6787738E−01 | −1.0817796E+00 | 4.4505485E+00 | −1.0460380E+01 |
| 5 | −4.7361848E+01 | −5.1469717E−03 | 1.3026080E−01 | −1.7035180E+00 | 4.3791508E+00 |
| 6 | −4.9996030E+01 | −1.9425485E−01 | 1.5095489E+00 | −7.7115253E+00 | 2.1925040E+01 |
| 7 | −1.3663300E+00 | 1.5785716E−02 | −3.1134998E−01 | 1.3401717E+00 | −2.8310176E+00 |
| 8 | −6.4948008E+00 | 1.9449329E−01 | −7.1829729E−01 | −1.4085730E−01 | 2.5124757E+00 |
| 9 | 2.5991652E+01 | 2.6854027E−01 | −5.2596495E−01 | 1.2053233E−03 | 1.4438293E−01 |
| 10 | −4.8014088E+01 | 1.2477793E−01 | −2.3326096E−01 | −2.2070426E−01 | 1.5325234E−01 |
| 11 | −5.0000000E+01 | 5.8345215E−02 | −9.5514326E−01 | 8.1600984E−01 | −5.0982706E−02 |
| 12 | −7.3575243E+00 | 1.1149529E−01 | −7.2681139E−01 | 8.3565416E−01 | −3.7486825E−01 |
| | A7 | A8 | A9 | A10 | |
| 2 | −4.4051745E+00 | 4.9317862E+00 | −3.3510424E+00 | 1.0389553E+00 | |
| 3 | 2.4599237E+01 | 1.6190539E+01 | −3.6875844E+01 | 1.6474133E+01 | |
| 4 | 1.6045263E+01 | −1.6407645E+01 | 1.0679509E+01 | −3.4013044E+00 | |
| 5 | −3.0265214E+00 | −6.5689893E+00 | 1.2449072E+01 | −5.9771358E+00 | |
| 6 | −3.8262153E+01 | 4.0450428E+01 | −2.4522067E+01 | 6.6453247E+00 | |
| 7 | 3.1492826E+00 | −1.0213141E+00 | −1.2571781E+00 | 8.1301145E−01 | |
| 8 | −4.3057811E+00 | 4.1038209E+00 | −2.1742018E+00 | 4.7683263E−01 | |
| 9 | −9.2140726E−02 | 2.0860003E−02 | 1.2662928E−01 | −7.0712799E−02 | |
| 10 | 8.1547746E−02 | −2.9619637E−02 | −1.8725215E−02 | 6.0921144E−03 | |
| 11 | −2.1891739E−01 | 1.2498625E−01 | −3.0332509E−02 | 2.8152236E−03 | |
| 12 | −1.4077679E−02 | 8.4649496E−02 | −3.4609674E−02 | 4.9367142E−03 | |

TABLE 17
Example 9
f = 3.26, Bf = 0.69

| Si | Ri | Di | Ndj | νdj |
|---|---|---|---|---|
| 1 (aperture stop) | ∞ | −0.21 | | |
| *2 | 1.3752 | 0.49 | 1.54492 | 55.89 |
| *3 | 21.8576 | 0.40 | 1.63351 | 23.63 |
| *4 | 2.8721 | 0.26 | | |
| *5 | 4.0270 | 0.39 | 1.54492 | 55.89 |
| *6 | 6.1455 | 0.25 | | |
| *7 | −5.1332 | 0.42 | 1.54492 | 55.89 |
| *8 | −1.7275 | 0.10 | | |
| *9 | 6.6664 | 0.32 | 1.63351 | 23.63 |
| *10 | 4.0341 | 0.23 | | |
| *11 | 2.3249 | 0.36 | 1.54492 | 55.89 |
| *12 | 0.9646 | 0.45 | | |
| 13 | ∞ | 0.11 | 1.51633 | 64.14 |
| 14 | ∞ | 0.17 | | |

*aspherical surface

TABLE 18
Example 9: Aspherical Surface Data

| Surface | | | | | |
|---|---|---|---|---|---|
| Number | K | A3 | A4 | A5 | A6 |
| 2 | 4.0869969E−01 | −7.0583559E−02 | 5.0904989E−01 | −1.8633915E+00 | 4.6496236E+00 |
| 3 | −5.0000000E+01 | 3.9249784E−01 | −3.7061804E+00 | 1.4995222E+01 | −3.2097300E+01 |
| 4 | −4.0474150E+01 | 4.5490714E−02 | −2.1337204E−01 | 1.8397017E+00 | −5.9628349E+00 |
| 5 | −5.2718429E+00 | −8.2215404E−02 | 5.4011208E−01 | −2.9628989E+00 | 6.1806522E+00 |
| 6 | −4.7584652E+01 | −2.2816992E−01 | 1.7206509E+00 | −8.1893716E+00 | 2.2384379E+01 |
| 7 | −3.5918159E+00 | 3.4202174E−03 | −1.9744966E−01 | 1.2208579E+00 | −3.1066710E+00 |
| 8 | −7.6730996E+00 | 1.4355134E−01 | −6.4590826E−01 | −2.4265335E−01 | 2.4931912E+00 |
| 9 | −1.6515585E+01 | 2.0903008E−01 | −6.8232826E−01 | 9.6976518E−02 | 1.8583044E−01 |
| 10 | 1.0036627E+00 | 7.8421950E−02 | −2.6854964E−01 | −2.2566176E−01 | 1.9021290E−01 |
| 11 | −4.9651094E+01 | 1.4250501E−02 | −8.8877728E−01 | 8.1558615E−01 | −6.5181754E−02 |
| 12 | −8.4773708E+00 | 1.0224828E−01 | −7.1176120E−01 | 8.3235667E−01 | −3.7914410E−01 |
| | A7 | A8 | A9 | A10 | |
| 2 | −7.4538539E+00 | 7.5245897E+00 | −4.3822430E+00 | 1.1484367E+00 | |
| 3 | 2.9917087E+01 | 4.8799916E+00 | −2.8486428E+01 | 1.4161893E+01 | |
| 4 | 1.1641550E+01 | −1.4568505E+01 | 1.0937630E+01 | −3.7098726E+00 | |
| 5 | −4.0695463E+00 | −6.0424022E+00 | 1.1280001E+01 | −5.1265896E+00 | |
| 6 | −3.8305048E+01 | 4.0318288E+01 | −2.4522067E+01 | 6.6453247E+00 | |
| 7 | 3.5498271E+00 | −7.7224451E−01 | −1.8236471E+00 | 1.0241705E+00 | |
| 8 | −4.1599031E+00 | 4.0541685E+00 | −2.2248425E+00 | 5.0163688E−01 | |
| 9 | −9.8600915E−02 | 7.0506909E−04 | 1.1852422E−01 | −6.2783073E−02 | |
| 10 | 8.2866469E−02 | −3.4606296E−02 | −2.6036822E−02 | 9.2580007E−03 | |
| 11 | −2.2375954E−01 | 1.2840606E−01 | −3.0205844E−02 | 2.7333635E−03 | |
| 12 | −1.0412590E−02 | 8.3194676E−02 | −3.4384434E−02 | 4.9544528E−03 | |

TABLE 19
Example 10
f = 3.27, Bf = 0.69

| Si | Ri | Di | Ndj | νdj |
|---|---|---|---|---|
| 1 (aperture stop) | ∞ | −0.21 | | |
| *2 | 1.3488 | 0.53 | 1.54492 | 55.89 |
| *3 | 7.3540 | 0.40 | 1.82115 | 24.06 |
| *4 | 2.8560 | 0.24 | | |
| *5 | 4.0198 | 0.39 | 1.54492 | 55.89 |
| *6 | 8.1943 | 0.26 | | |
| *7 | −3.8872 | 0.38 | 1.54492 | 55.89 |
| *8 | −1.3888 | 0.10 | | |
| *9 | 10.1004 | 0.32 | 1.63351 | 23.63 |
| *10 | 3.6410 | 0.24 | | |
| *11 | 2.5089 | 0.36 | 1.54492 | 55.89 |
| *12 | 0.9766 | 0.45 | | |
| 13 | ∞ | 0.11 | 1.51633 | 64.14 |
| 14 | ∞ | 0.17 | | |

*aspherical surface

TABLE 20
Example 10: Aspherical Surface Data

| Surface | | | | | |
|---|---|---|---|---|---|
| Number | K | A3 | A4 | A5 | A6 |
| 2 | 3.0775171E−01 | −9.0014324E−02 | 6.0723579E−01 | −1.9712934E+00 | 4.4297829E+00 |
| 3 | −5.0000000E+01 | 3.7307208E−01 | −3.3717404E+00 | 1.3751134E+01 | −2.9220768E+01 |
| 4 | −4.0563026E+01 | 6.5479343E−02 | −2.5440275E−01 | 1.8518520E+00 | −5.9750743E+00 |
| 5 | −5.2746074E+00 | −8.0264900E−02 | 5.5628100E−01 | −2.9254336E+00 | 6.1341535E+00 |
| 6 | −4.7375993E+01 | −2.2241335E−01 | 1.7359110E+00 | −8.1739519E+00 | 2.2332096E+01 |
| 7 | −3.4905114E+00 | −8.6845478E−03 | −4.9894235E−02 | 1.0492630E+00 | −3.1178171E+00 |
| 8 | −7.5046553E+00 | 1.9566014E−01 | −7.2189475E−01 | −2.3816216E−01 | 2.5292160E+00 |
| 9 | −1.6289229E+01 | 2.6069848E−01 | −7.0151417E−01 | 6.8036184E−02 | 1.8040376E−01 |
| 10 | 1.0032233E+00 | 6.3410209E−02 | −2.6902847E−01 | −2.2672728E−01 | 1.9190572E−01 |
| 11 | −4.9995594E+01 | −1.2108524E−02 | −8.7659879E−01 | 8.2019514E−01 | −6.5055752E−02 |
| 12 | −8.3355957E+00 | 9.4936721E−02 | −7.1362234E−01 | 8.3665717E−01 | −3.7885528E−01 |
| | A7 | A8 | A9 | A10 | |
| 2 | −6.7635098E+00 | 7.2783793E+00 | −5.0367133E+00 | 1.6884437E+00 | |
| 3 | 2.6625281E+01 | 4.5952643E+00 | −2.5225552E+01 | 1.2405119E+01 | |
| 4 | 1.1864150E+01 | −1.4986938E+01 | 1.1093701E+01 | −3.6523142E+00 | |
| 5 | −4.0212296E+00 | −6.4972702E+00 | 1.2262531E+01 | −5.7073027E+00 | |
| 6 | −3.8297977E+01 | 4.0341657E+01 | −2.4522067E+01 | 6.6453247E+00 | |
| 7 | 3.6680840E+00 | −7.2215524E−01 | −1.9932790E+00 | 1.0909663E+00 | |
| 8 | −4.1359715E+00 | 4.0303875E+00 | −2.2528720E+00 | 5.1992376E−01 | |
| 9 | −9.5369511E−02 | 1.7408426E−02 | 1.1646438E−01 | −6.5967883E−02 | |
| 10 | 8.3282083E−02 | −3.4709512E−02 | −2.6095293E−02 | 9.2365158E−03 | |
| 11 | −2.2470167E−01 | 1.2791242E−01 | −3.0230863E−02 | 2.8312277E−03 | |
| 12 | −1.0970171E−02 | 8.2945469E−02 | −3.4422118E−02 | 5.0058437E−03 | |

TABLE 21
Example 11
f = 3.27, Bf = 0.68

| Si | Ri | Di | Ndj | νdj |
|---|---|---|---|---|
| 1 (aperture stop) | ∞ | −0.21 | | |
| *2 | 1.3643 | 0.55 | 1.54492 | 55.89 |
| *3 | −61.1788 | 0.40 | 1.68893 | 31.08 |
| *4 | 2.9401 | 0.24 | | |
| *5 | 3.5909 | 0.39 | 1.54492 | 55.89 |
| *6 | 5.9837 | 0.25 | | |
| *7 | −5.2300 | 0.40 | 1.54492 | 55.89 |
| *8 | −1.5516 | 0.10 | | |
| *9 | 11.6955 | 0.32 | 1.63351 | 23.63 |
| *10 | 4.0956 | 0.22 | | |
| *11 | 2.2891 | 0.36 | 1.54492 | 55.89 |
| *12 | 0.9384 | 0.45 | | |
| 13 | ∞ | 0.11 | 1.51633 | 64.14 |
| 14 | ∞ | 0.16 | | |

*aspherical surface

TABLE 22
Example 11: Aspherical Surface Data

| Surface | | | | | |
|---|---|---|---|---|---|
| Number | K | A3 | A4 | A5 | A6 |
| 2 | 4.2923135E−01 | −8.1617134E−02 | 5.7475557E−01 | −2.0171753E+00 | 4.7427131E+00 |
| 3 | 4.5525750E+01 | 4.3338265E−01 | −3.9544063E+00 | 1.5469438E+01 | −3.2231121E+01 |
| 4 | −4.0575489E+01 | 5.3391172E−02 | −2.6547815E−01 | 1.8498131E+00 | −5.8959942E+00 |
| 5 | −5.2142228E+00 | −9.2219081E−02 | 5.7264299E−01 | −2.9776387E+00 | 6.1736755E+00 |
| 6 | −4.1000077E+01 | −2.3374573E−01 | 1.7317236E+00 | −8.2014330E+00 | 2.2384709E+01 |
| 7 | −4.2021355E+00 | −7.5079076E−03 | −1.8042647E−01 | 1.1989853E+00 | −3.0958995E+00 |
| 8 | −7.6027710E+00 | 1.5106658E−01 | −6.6096794E−01 | −2.3037424E−01 | 2.5021005E+00 |
| 9 | −2.2111065E+01 | 2.2510751E−01 | −6.7301078E−01 | 8.2175296E−02 | 1.8016103E−01 |
| 10 | 9.9684261E−01 | 7.3226867E−02 | −2.6920882E−01 | −2.2297607E−01 | 1.9120125E−01 |
| 11 | −4.9802434E+01 | 7.9164666E−03 | −8.8576656E−01 | 8.1597896E−01 | −6.5305248E−02 |
| 12 | −8.3115257E+00 | 1.0788229E−01 | −7.1851041E−01 | 8.3482744E−01 | −3.7863558E−01 |
| | A7 | A8 | A9 | A10 | |
| 2 | −7.2454775E+00 | 7.4522628E+00 | −4.9043684E+00 | 1.6203684E+00 | |
| 3 | 2.8844423E+01 | 5.1179179E+00 | −2.6609824E+01 | 1.2644153E+01 | |
| 4 | 1.1674755E+01 | −1.4721372E+01 | 1.0798297E+01 | −3.4889481E+00 | |
| 5 | −4.0573598E+00 | −6.0360558E+00 | 1.1344668E+01 | −5.2219834E+00 | |
| 6 | −3.8261579E+01 | 4.0287563E+01 | −2.4522067E+01 | 6.6453247E+00 | |
| 7 | 3.5643709E+00 | −7.7474817E−01 | −1.8373039E+00 | 1.0264794E+00 | |
| 8 | −4.1603810E+00 | 4.0463298E+00 | −2.2335755E+00 | 5.0791873E−01 | |
| 9 | −9.6814190E−02 | 5.5808285E−03 | 1.2112598E−01 | −6.5714426E−02 | |
| 10 | 8.2628959E−02 | −3.5144748E−02 | −2.6263847E−02 | 9.4332846E−03 | |
| 11 | −2.2387177E−01 | 1.2835367E−01 | −3.0228054E−02 | 2.7516929E−03 | |
| 12 | −1.0636626E−02 | 8.2999088E−02 | −3.4433677E−02 | 4.9906829E−03 | |

TABLE 23
Example 12
f = 3.27, Bf = 0.69

| Si | Ri | Di | Ndj | νdj |
|---|---|---|---|---|
| 1 (aperture stop) | ∞ | −0.21 | | |
| *2 | 1.3589 | 0.55 | 1.54001 | 55.00 |
| *3 | −190.5377 | 0.40 | 1.68893 | 31.08 |
| *4 | 2.9362 | 0.23 | | |
| *5 | 3.5643 | 0.39 | 1.54492 | 55.89 |
| *6 | 5.9772 | 0.26 | | |
| *7 | −5.2048 | 0.40 | 1.54492 | 55.89 |
| *8 | −1.5507 | 0.10 | | |
| *9 | 11.2468 | 0.32 | 1.63351 | 23.63 |
| *10 | 4.0421 | 0.22 | | |
| *11 | 2.2952 | 0.36 | 1.54492 | 55.89 |
| *12 | 0.9387 | 0.45 | | |
| 13 | ∞ | 0.11 | 1.51633 | 64.14 |
| 14 | ∞ | 0.16 | | |

*aspherical surface

TABLE 24
Example 12: Aspherical Surface Data

| Surface | | | | | |
|---|---|---|---|---|---|
| Number | K | A3 | A4 | A5 | A6 |
| 2 | 4.2977254E−01 | −8.2815943E−02 | 5.7971001E−01 | −2.0249575E+00 | −4.7479231E+00 |
| 3 | 4.5525750E+01 | 4.3142501E−01 | −3.9461988E+00 | 1.5430969E+01 | −3.2166212E+01 |
| 4 | −4.0575258E+01 | 5.3539492E−02 | −2.6660816E−01 | 1.8463525E+00 | −5.8905932E+00 |
| 5 | −5.2142075E+00 | −9.2826907E−02 | 5.7484833E−01 | −2.9791449E+00 | 6.1753949E+00 |
| 6 | −4.1000040E+01 | −2.3360481E−01 | 1.7323774E+00 | −8.2022747E+00 | 2.2384355E+01 |
| 7 | −4.2021386E+00 | −7.2353294E−03 | −1.8016643E−01 | 1.1978941E+00 | −3.0955726E+00 |
| 8 | −7.6041497E+00 | 1.5089126E−01 | −6.6116423E−01 | −2.3021584E−01 | 2.5026151E+00 |
| 9 | −2.2111064E+01 | 2.2390587E−01 | −6.7296203E−01 | 8.2026869E−02 | 1.8016565E−01 |
| 10 | 9.9740385E−01 | 7.2421539E−02 | −2.6979123E−01 | −2.2274991E−01 | 1.9124206E−01 |
| 11 | −4.9801322E+01 | 7.5852209E−03 | −8.8585358E−01 | 8.1594929E−01 | −6.5280994E−02 |
| 12 | −8.3085743E+00 | 1.0801061E−01 | −7.1929146E−01 | 8.3547522E−01 | −3.7878961E−01 |
| | A7 | A8 | A9 | A10 | |
| 2 | −7.2431959E+00 | 7.4552156E+00 | −4.9193703E+00 | 1.6334052E+00 | |
| 3 | 2.8801719E+01 | 5.0354246E+00 | −2.6463406E+01 | 1.2578793E+01 | |
| 4 | 1.1671122E+01 | −1.4722063E+01 | 1.0788852E+01 | −3.4771894E+00 | |
| 5 | −4.0596145E+00 | −6.0357978E+00 | 1.1347665E+01 | −5.2253977E+00 | |
| 6 | −3.8258198E+01 | 4.0285524E+01 | −2.4522067E+01 | 6.6453247E+00 | |
| 7 | 3.5655340E+00 | −7.7389469E−01 | −1.8389766E+00 | 1.0270033E+00 | |
| 8 | −4.1600235E+00 | 4.0461496E+00 | −2.2340836E+00 | 5.0801065E−01 | |
| 9 | −9.6771648E−02 | 5.7443469E−03 | 1.2118944E−01 | −6.5852311E−02 | |
| 10 | 8.2628330E−02 | −3.5162329E−02 | −2.6278925E−02 | 9.4431304E−03 | |
| 11 | −2.2384716E−01 | 1.2836788E−01 | −3.0228085E−02 | 2.7470835E−03 | |
| 12 | −1.0624359E−02 | 8.2978860E−02 | −3.4431553E−02 | 4.9924778E−03 | |

TABLE 25
Example 13
f = 3.31, Bf = 0.62

| Si | Rd | Di | Ndj | νdj |
|---|---|---|---|---|
| 1 (aperture stop) | ∞ | −0.21 | | |
| *2 | 1.2934 | 0.56 | 1.51900 | 55.00 |
| *3 | 8.6323 | 0.40 | 1.82115 | 24.06 |
| *4 | 3.0260 | 0.25 | | |
| *5 | 3.5162 | 0.39 | 1.54492 | 55.89 |
| *6 | 5.1266 | 0.25 | | |
| *7 | −6.7047 | 0.38 | 1.54492 | 55.89 |
| *8 | −1.8996 | 0.10 | | |
| *9 | 5.4641 | 0.32 | 1.63351 | 23.63 |
| *10 | 3.0023 | 0.25 | | |
| *11 | 2.3584 | 0.39 | 1.54492 | 55.89 |
| *12 | 0.9754 | 0.45 | | |
| 13 | ∞ | 0.11 | 1.51633 | 64.14 |
| 14 | ∞ | 0.10 | | |

*aspherical surface

TABLE 26
Example 13: Aspherical Surface Data

| Surface | | | | | |
|---|---|---|---|---|---|
| Number | K | A3 | A4 | A5 | A6 |
| 2 | −2.0012378E−01 | −7.2928106E−02 | 5.9730036E−01 | −2.2897163E+00 | 6.5559624E+00 |
| 3 | −5.0000000E+01 | 1.3520111E−01 | −1.0163810E+00 | 3.3787224E+00 | −7.8071113E+00 |
| 4 | −4.2743220E+01 | 1.9074622E−02 | 1.8520694E−02 | 8.2424079E−01 | −3.9904675E+00 |
| 5 | −9.2898359E+00 | −1.8963503E−01 | 1.2821699E+00 | −5.2895639E+00 | 9.7162912E+00 |
| 6 | −2.8759178E+01 | −2.8400565E−01 | 2.1002902E+00 | −9.0887168E+00 | 2.3100356E+01 |
| 7 | 9.5861065E+00 | 3.3109560E−02 | −1.7981237E−01 | 1.7313016E+00 | −4.6702835E+00 |
| 8 | −9.1388902E+00 | 1.4845907E−01 | −1.8056911E−01 | −9.2451111E−01 | 2.0718547E+00 |
| 9 | −4.7573198E+00 | 1.5066331E−01 | −2.9347602E−01 | −6.3581839E−01 | 4.6353495E−01 |
| 10 | 7.7663537E−01 | −5.0095107E−02 | −1.4631820E−01 | −2.8118984E−01 | 1.7796840E−01 |
| 11 | −4.9918981E+01 | −5.9683089E−02 | −8.6874560E−01 | 8.2092717E−01 | −5.7486964E−02 |
| 12 | −1.0161538E+01 | 1.5947038E−01 | −7.8310368E−01 | 8.5976035E−01 | −3.7993442E−01 |
| | A7 | A8 | A9 | A10 | |
| 2 | −1.2070274E+01 | 1.4096568E+01 | −9.5346959E+00 | 2.8914804E+00 | |
| 3 | 1.3301572E+01 | −1.6585629E+01 | 1.3135228E+01 | −4.7976366E+00 | |
| 4 | 1.0688320E+01 | −1.6809113E+01 | 1.4294460E+01 | −5.0082261E+00 | |
| 5 | −5.3694018E+00 | −9.0024137E+00 | 1.5073860E+01 | −6.5058239E+00 | |
| 6 | −3.8177555E+01 | 4.0043406E+01 | −2.4522067E+01 | 6.6453247E+00 | |
| 7 | 4.0945141E+00 | 1.2166537E+00 | −3.9227186E+00 | 1.6057032E+00 | |
| 8 | −3.2859856E+00 | 4.1236322E+00 | −2.6699728E+00 | 6.3440777E−01 | |
| 9 | 1.9454011E−02 | 9.2987435E−02 | −5.1515959E−02 | −1.7615673E−02 | |
| 10 | 8.8734440E−02 | −2.5585815E−02 | −2.7965578E−02 | 8.5596976E−03 | |
| 11 | −2.2309959E−01 | 1.2748266E−01 | −3.2547741E−02 | 3.5921259E−03 | |
| 12 | −9.7137488E−03 | 8.3113374E−02 | −3.5147989E−02 | 5.1490699E−03 | |

TABLE 27
Values Related to Conditional Formulae

| | | Example | Example | Example | Example | Example | Example | Example |
|---|---|---|---|---|---|---|---|---|
| Formula | Condition | 1 | 2 | 3 | 4 | 5 | 6 | 7 |
| 1 | f/f12 | 0.795 | 0.802 | 0.815 | 0.751 | 0.808 | 0.942 | 0.820 |
| 2 | f/R6r | 3.011 | 3.283 | 2.771 | 3.257 | 3.052 | 2.885 | 2.758 |
| 3 | T2/T1 | 0.178 | 0.183 | 0.194 | 0.450 | 0.459 | 0.197 | 0.188 |
| 4 | f/f6 | −1.202 | −1.121 | −1.268 | −0.998 | −1.019 | −1.196 | −1.269 |
| 5 | T12/f | 0.264 | 0.258 | 0.246 | 0.267 | 0.273 | 0.240 | 0.252 |

| | | Example | Example | Example | Example | Example | Example |
|---|---|---|---|---|---|---|---|
| Formula | Condition | 8 | 9 | 10 | 11 | 12 | 13 |
| 1 | f/f12 | 0.784 | 0.745 | 0.708 | 0.714 | 0.711 | 0.748 |
| 2 | f/R6r | 3.338 | 3.379 | 3.351 | 3.481 | 3.482 | 3.398 |
| 3 | T2/T1 | 0.200 | 0.816 | 0.755 | 0.727 | 0.727 | 0.714 |
| 4 | f/f6 | −1.064 | −0.977 | −1.023 | −1.014 | −1.017 | −0.978 |
| 5 | T12/f | 0.258 | 0.273 | 0.284 | 0.291 | 0.291 | 0.290 |

What is claimed is:

1. An imaging lens substantially consisting of six lenses, including:
a first lens having a positive refractive power and a convex surface toward the object side;
a second lens, which is cemented to the first lens, having a negative refractive power and a concave surface toward the image side;
a third lens;
a fourth lens;
a fifth lens; and
a sixth lens, provided in this order from the object side;
the imaging lens satisfying the following conditional formulae:
0.4<f/f12<1.3 (1)
1.5<f/R6r<5 (2-1)
wherein f is the focal length of the entire system, f12 is the combined focal length of the first lens and the second lens, and R6r is the paraxial radius of curvature of the surface of the sixth lens toward the image side.

2. An imaging lens as defined in claim 1, wherein:
the coupling surface between the first lens and the second lens is of an aspherical shape.

3. An imaging lens as defined in claim 1 that further satisfies the conditional formula below:
0.1<T2/T1<1.0 (3)
wherein T2 is the central thickness of the second lens and T1 is the central thickness of the first lens.

4. An imaging lens as defined in claim 1, wherein:
the sixth lens has a negative refractive power.

5. An imaging lens as defined in claim 1 that further satisfies the conditional formula below:
−5<f/f6<−0.7 (4)
wherein f6 is the focal length of the sixth lens.

6. An imaging lens as defined in claim 1, wherein:
the fourth lens has a positive refractive power.

7. An imaging lens as defined in claim 1, wherein:
the third lens has a positive refractive power.

8. An imaging lens as defined in claim 1 that further satisfies the conditional formula below:
0.15<T12/f<0.35 (5)
wherein T12 is the total thickness of the cemented lens formed by the first lens and the second lens along the optical axis.

9. An imaging lens as defined in claim 1 that further satisfies the conditional formula below:
0.5<f/f12<1.1 (1-1).

10. An imaging lens as defined in claim 1 that further satisfies the conditional formula below:
0.1<T2/T1<0.3 (3-1)
wherein T2 is the central thickness of the second lens, and T1 is the central thickness of the first lens.

11. An imaging lens as defined in claim 1 that further satisfies the conditional formula below:
−2<f/f6<−0.9 (4-1)
wherein f6 is the focal length of the sixth lens.

12. An imaging lens as defined in claim 1 that further satisfies the conditional formula below:
0.2<T12/f<0.3 (5-1)
wherein T12 is the total thickness of the cemented lens formed by the first lens and the second lens along the optical axis.

13. An imaging lens as defined in claim 1, wherein:
an aperture stop is positioned at the object side of the surface of the first lens toward the object side.

14. An imaging apparatus equipped with the imaging lens defined in claim 1.
